(19) United States
(12) Patent Application Publication
(10) Pub. No.: US 2012/0016911 A1
(43) Pub. Date: Jan. 19, 2012

(54) CHILD IMPACT STATEMENT REPORTING SYSTEM

(76) Inventor: MICHAEL SCHMIDT, Memphis, TN (US)

(21) Appl. No.: 13/087,545

(22) Filed: Apr. 15, 2011

Related U.S. Application Data
(60) Provisional application No. 61/324,402, filed on Apr. 15, 2010.

(51) Int. Cl. G06F 7/00

(52) U.S. Cl. 707/803; 707/E17.044

(57) ABSTRACT

A system for commissioners, citizens, groups, agencies, and other authors of proposals, ordinances, legislation or other acts to prepare, review and submit a Child Impact Statement (CIS). The system comprises a series of computer-based tools implementing a process of creating a CIS to identify areas of child well-being that could be affected by the proposal. The system further comprises a database containing information collected and compiled into graphs, maps, charts, tables, and other forms, to allow users to create and compare evidence relating to the proposal in question.

This application claims benefit of and priority to U.S. Provisional Application No. 61/324,402, filed Apr. 15, 2010, by Michael Schmidt, and is entitled to that filing date for priority. The specification, figures, attachments and complete disclosure of U.S. Provisional Application No. 61/324,402 are incorporated herein by specific reference for all purposes.

### FIELD OF INVENTION

This invention relates to a system and related methods for creating and reviewing Child Impact Statements, Assessments or Reports for legislative and executive policies and acts.

### BACKGROUND OF THE INVENTION

In 1990, the United Nations Convention on the Rights of the Child (CRC) became the foundation on which new approaches toward considering children's rights in proposed legislation currently rest. For instance, the European Union, in alignment with the CRC, developed the European Strategy for Children in the Parliamentary Assembly of the Council of Europe in 1996. In this document, recommendations were made for Member States to ensure that, especially at the policy-making level, the interests and needs of children be considered. It is through the European Strategy for Children project that the European Union determined that Child Impact Statements (CIS) are needed in order to take into account the probable impact on children in any proposed legislation.

This set in motion a multitude of acts and bills requesting that countries include children's rights considerations in proposed legislation. In 1997, Belgium passed an act that required all draft acts affecting children to be accompanied by a Child Impact Assessment when presented to Parliament. Sweden passed a bill endorsing a national strategy for implementing the UN CRC that included a requirement that national government decisions affecting children be assessed for their impact on them, and recommended that local government set up systems, such as Child Impact Assessments and Child Accounting, to monitor the realization of the best interests of the child in local and regional government. Similarly, Finland's 2005 national action plan for children recommends the use of child impact assessments. The terms child impact assessments, child impact reports and child impact statements are often used interchangeably.

In the United States, county governments and advocacy groups continue to address the need for integrating child impact statements with proposed policy. The distinction between child well-being initiatives in the United States and those abroad lies in the difference between established rules and mandates, as the United States has not ratified the CRC. While other countries rely on the Articles listed in the CRC in considering children's rights in policy-making, the United States abides by laws set out in the United States Constitution as an official means of considering the well-being of its children.

In 1997, President Clinton signed Executive Order 13045 titled, “Protection of Children from Environmental Health Risks and Safety Risks.” This brought to light child well-being issues and a need for overseeing the implementation of the Order. In keeping with the provisions of the Order, the United States Environmental Protection Agency is charged with the duty of ensuring that the well-being of children is considered by way of environmental impact assessments, and has funded a project with the World Health Organization titled, “Children's Environmental Health Indicators.” An annual report is published that examines child well-being as it relates to the environment.

The Federal Interagency Forum on Child and Family Statistics is a Task Force member appointed in the Order to assist in recommending to the U.S. President federal strategies for children's environmental health and safety. An annual report titled “America's Children: Key National Indicators of Well-Being” explains child well-being indicator criteria, and gives examples of indicators nationwide.

These annual reports of child well-being and the defining of indicators of child well-being on a national level have led to statewide recommendations for child impact statements in the U.S. Official requests for proposed legislation to contain child impact statements do not identify exactly what form these statements will take or who will be responsible for monitoring adherence to these provisions or measuring the effectiveness of child impact statements once they are implemented. In spite of this, numerous states and cities in the U.S. continue to make progress toward these goals.

In Tennessee, for example, Tennessee Governor Phil Bredesen in 2003 signed Executive Order 7, which created the Governor's Children's Cabinet. Under this Order, thirteen Children's Cabinet members have a duty to coordinate and streamline Tennessee's efforts to provide needed services to Tennessee's children, and to “focus on a broad range of issues and challenges, including but not limited to fighting abuse and neglect, promoting foster care and adoption, and raising public awareness of children's issues.” Similarly, Tennessee Code Annotated Section 37-3-103 pays particular attention to addressing the well-being of children, stating that:
(b) To the extent that adequate resources are available, the commission is authorized to perform any one (1) or more of the following activities:
. . . (2) Prepare and distribute impact statements analyzing the potential effect of proposals under consideration by the general assembly that relate to the health, well being and development of children and youth; . . .

As one of the appointed Governor's Children's Cabinet members, the Executive Director of Tennessee Commission on Children and Youth (TCCY) currently carries out Cabinet member duties, as well as the mandates stipulated in Tennessee Code Annotated Section 37-3-103. The TCCY serves as an advocacy group for the public and an advisory group to the Assembly by reporting to legislators the impacts that proposed legislation will likely have on the well-being of Tennessee's children. The TCCY participates with the KidsCount databook and produces an annual report of data on Tennessee children.

At the county level in Tennessee, even greater steps were recently taken toward integrating child impact statements into proposed policy. In Shelby County, for example, the Tennessee Shelby County Commission approved the use of a Child Impact Statement with legislative proposals.

However, despite the movement towards requiring the preparation and evaluation of the impacts proposed legislation may have on children, there previously has been no effective tool to assist such agencies, groups and individuals in preparing a Child Impact Statement, Assessment or Report.

### SUMMARY OF INVENTION

In various embodiments, the present invention comprises an online web application for commissioners, citizens, groups, agencies, and other authors of proposals, ordinances, legislation or other acts to prepare, review and submit a Child Impact Statement (CIS). The system comprises a series of tools implementing a process of creating a Child Impact Statement to identify areas of child well-being that could be affected by the proposal. The system further comprises a database containing information collected and compiled into graphs, charts, tables, and other forms, to allow users to create and compare evidence relating to the proposal in question.

### BRIEF DESCRIPTION OF THE DRAWINGS

FIG. 1 is a diagram of an embodiment of the present invention in conjunction with a typical decision-making workflow process.

FIGS. 2-3 show an example of an introductory web page for a system in accordance with an exemplary embodiment of the present invention.

FIG. 4 shows an overview page for an exemplary system.

FIG. 5 shows a features summary page for an exemplary system.

FIG. 6 shows a glossary page for an exemplary system.

FIG. 7 shows a FAQ page for an exemplary system.

FIG. 8 shows a contact page for an exemplary system.

FIG. 9 shows an example of a log-in page for an exemplary system.

FIG. 10 shows an account creation page for an exemplary system.

FIG. 11 shows an account modification page for an exemplary system.

FIG. 12 shows a statements page for an exemplary system.

FIG. 13 shows a statement creation page for an exemplary system.

FIG. 14 shows a statement cloning page for an exemplary system.

FIG. 15 shows a statement sharing page for an exemplary system.

FIG. 16 shows a statement ownership transfer page for an exemplary system.

FIGS. 17-18 show an example of a user interface page for statement content creation for an exemplary system.

FIG. 19 shows an explore tab selection page for an exemplary system.

FIG. 20 shows a scenario detail window for an exemplary system.

FIG. 21 shows a search resources tab selection page for an exemplary system.

FIG. 22 shows a resource configuration page for an exemplary system.

FIG. 23 shows an example of an article resource.

FIG. 24 shows an example of a brief resource.

FIG. 25 shows a maps tab selection page for an exemplary system.

FIGS. 26-28 show examples of customized maps.

FIG. 29 shows a resources tab selection page for an exemplary system.

FIG. 30 shows a return tab selection page for an exemplary system.

FIG. 31 shows a reassessment tab selection page for an exemplary system.

FIG. 32 shows a rate tab selection page for an exemplary system.

FIGS. 33-35 show an example of a statement outline form.

FIGS. 36-41 show examples of scenario listing and modification pages for an exemplary system.

FIGS. 42-45 show examples of graph listing and modification pages for an exemplary system.

FIGS. 46-48 show examples of article listing and modification pages for an exemplary system.

FIG. 49 shows an example of a master domain listing for an exemplary system.

FIG. 50 shows a domain modification page for an exemplary system.

FIG. 51 shows an example of a master key principal indicator listing for an exemplary system.

FIG. 52 shows a key principal indicator modification page for an exemplary system.

FIG. 53 shows an example of a master policy listing for an exemplary system.

FIG. 54 shows a policy modification page for an exemplary system.

FIG. 55 shows an example of a master feature listing for an exemplary system.

FIG. 56 shows an example of a master glossary listing for an exemplary system.

FIG. 57 shows an example of a master FAQ listing for an exemplary system.

### DETAILED DESCRIPTION OF EXEMPLARY EMBODIMENTS

In one exemplary embodiment, the present invention comprises a computer-based Child Impact Statement Reporting System (CISRS). The CISRS is a child and family-focused framework for policy planning, evaluation, and decision-making. The CISRS is an end-stage screening tool, as well as a framework for planning new initiatives, evaluating ideas and proposals, and considering the risks and benefits of proposed actions and alternatives. In addition to delivering information in ways people can understand and use, CISRS offers a carefully designed and tested set of prompts, instructions, and examples that help users locate and respond to the conditions, needs, and risks existing within the community. It generates impact statements to inform the legislative process from the earliest identification and determination of policy needs forward.

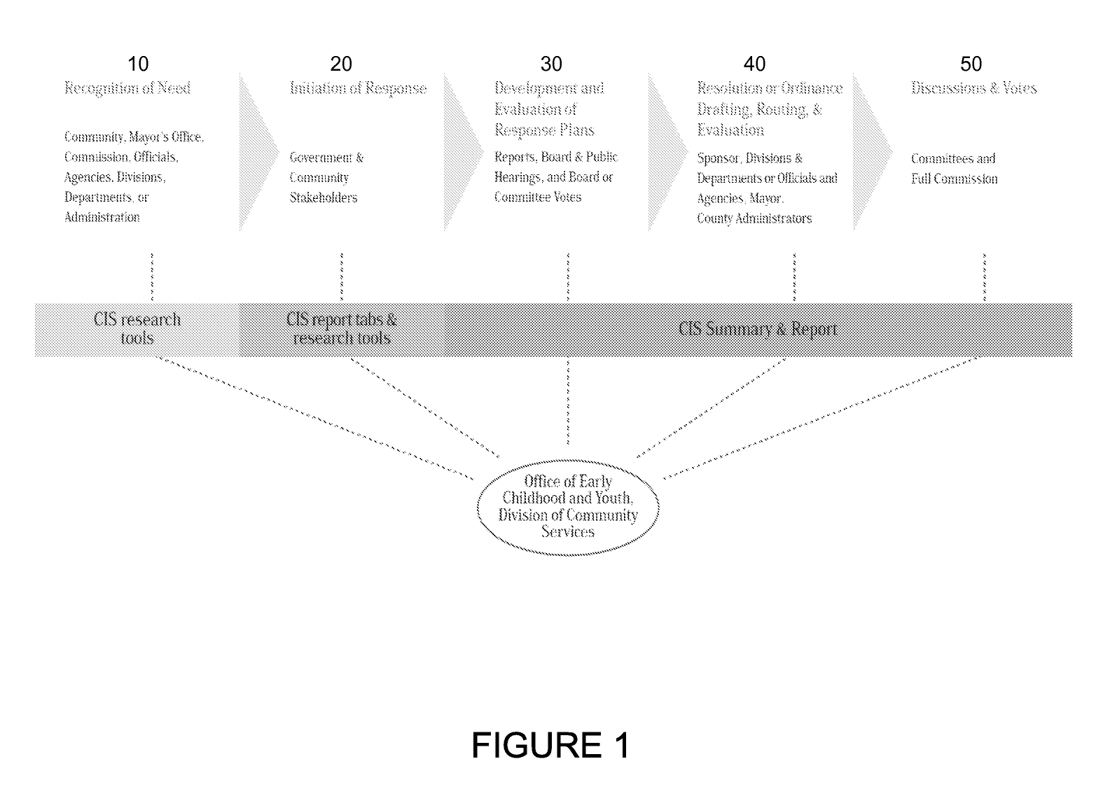

The CISRS can cover the entire decision-making workflow process, as shown in FIG. 1. The various stages of the workflow process (recognition of need 10, initiation of response 20, development and evaluation of response plans 30, resolution or ordinance drafting, routing and evaluation 40, and discussions and voting 50), along with likely participants, are shown. A CIS may be started from the very outset of an idea, initiative, or proposal, or may be started when the effort already is underway. The CISRS can be used for initial research and analysis, as well as the preparation of the CIS summary and report itself.

In various embodiments, the CISRS provides topic summaries on numerous domains of child well-being, data in charts and graphs, and data summaries. The system may be accessed through a web browser, or comprise a stand-alone program or application. The topics and data included cut across sectors from public safety to health, education, and jobs. The data indicators can cover counties with the densest populations as well as a state (or other political entity) as a whole. In one embodiment, data are county-level, while reports track national trends. The system also may include census tract data and other sub-county information. These information resources, along with the planning and decision-making tools comprising the invention, provide a platform that can be used throughout the policy research, planning, decision-making, and outcomes evaluation cycle.

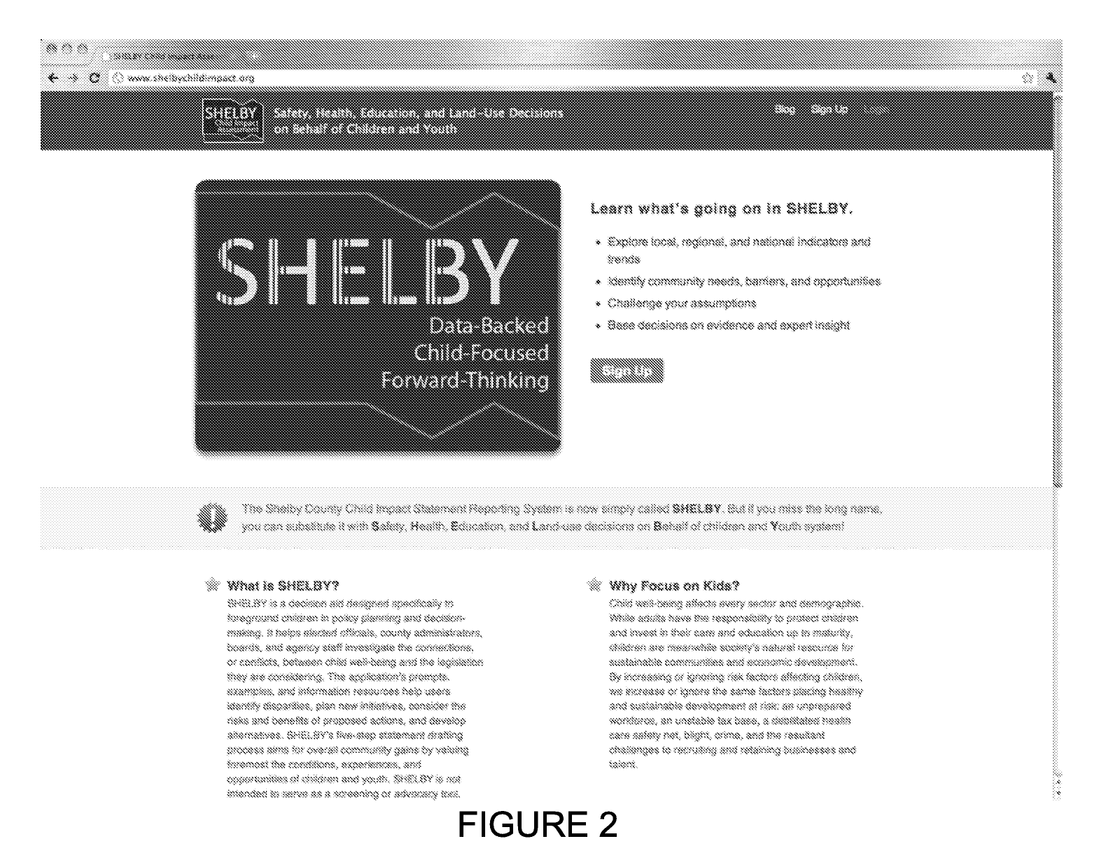

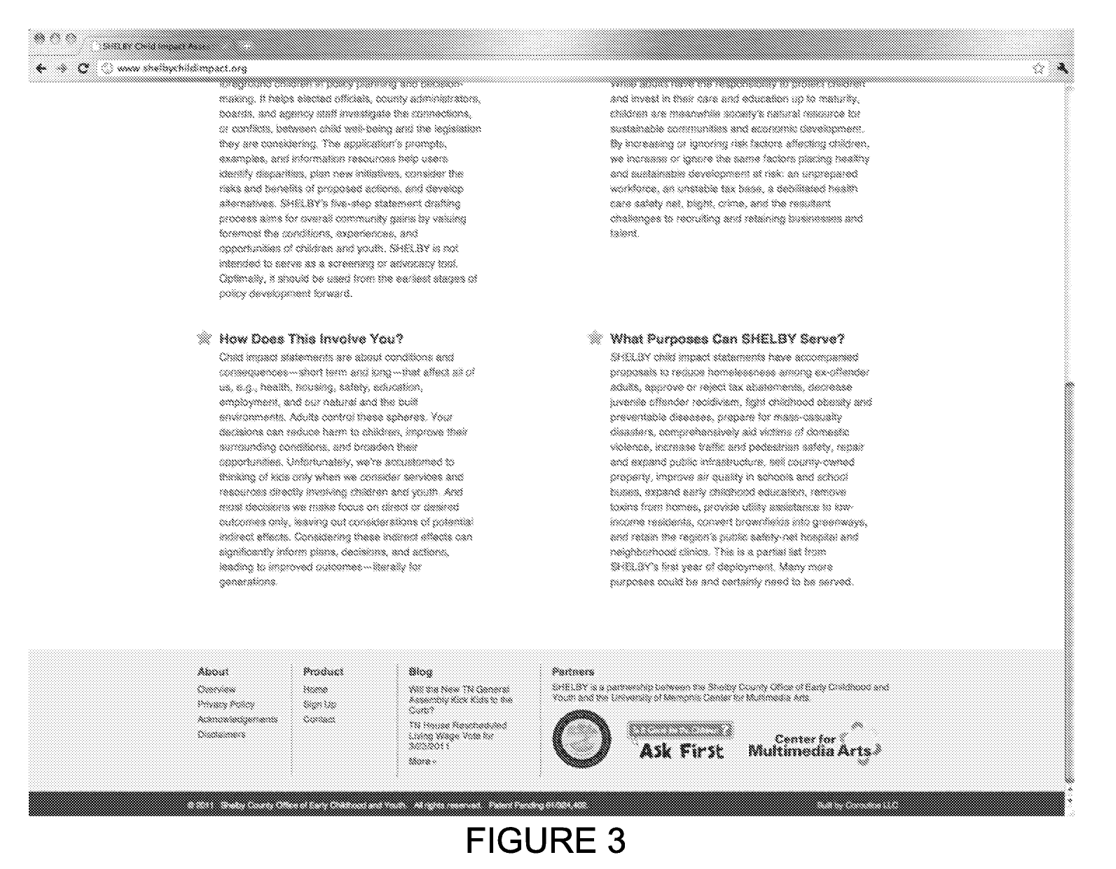

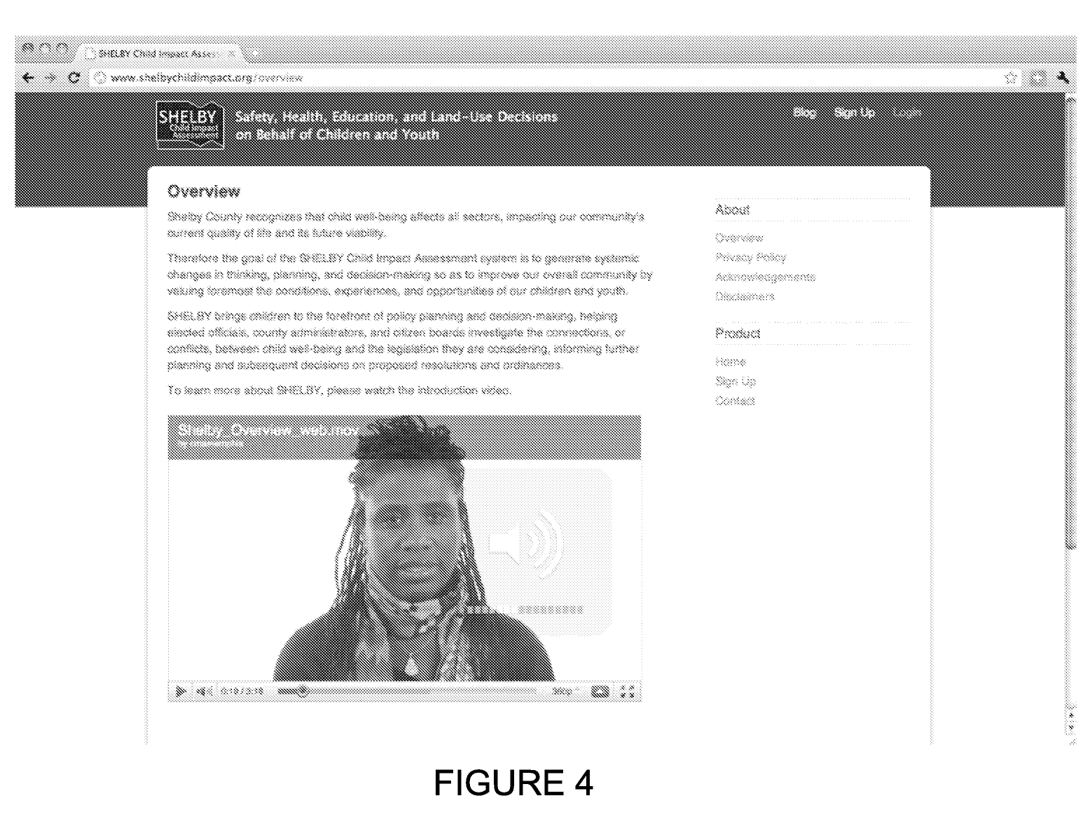

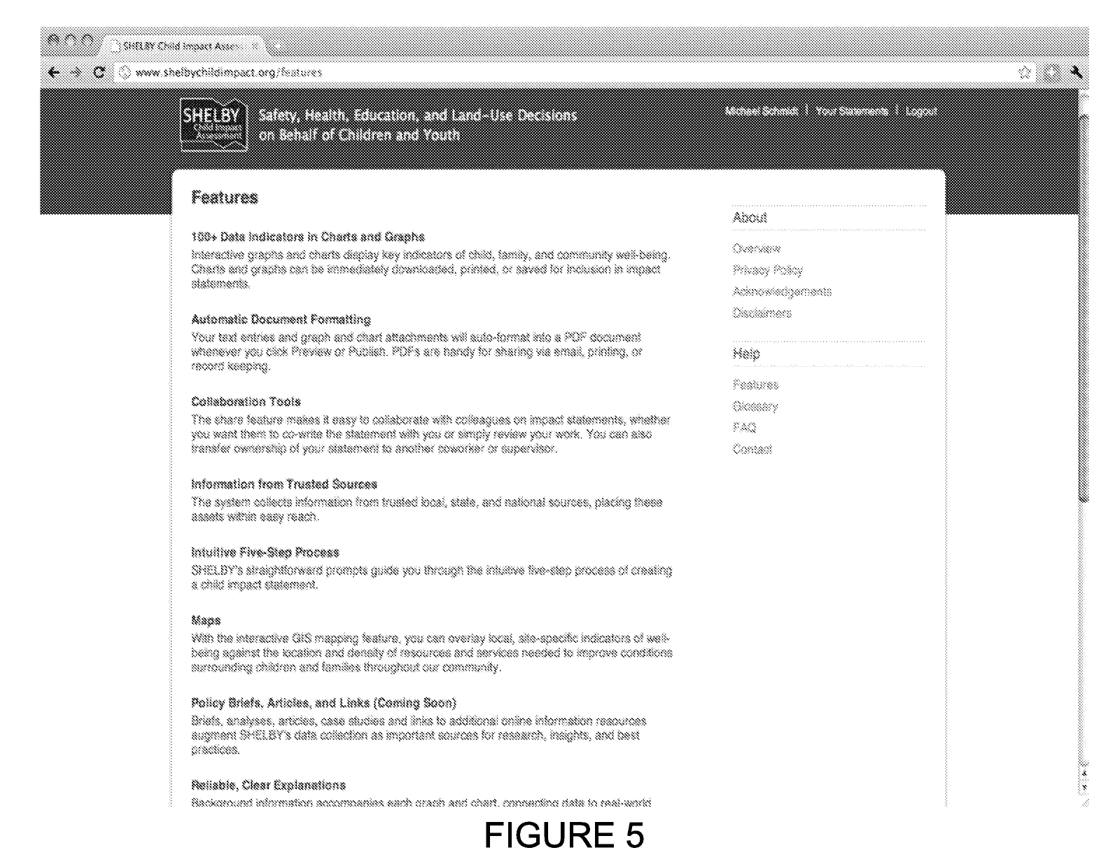

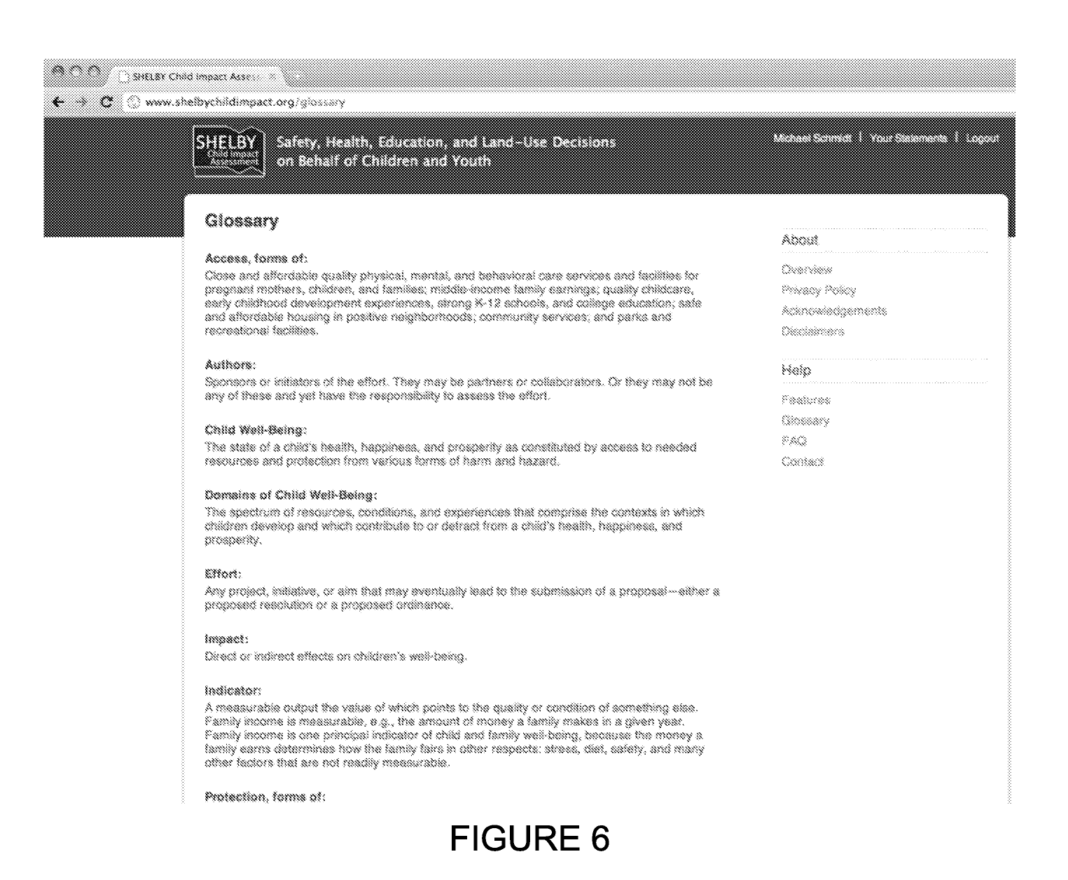

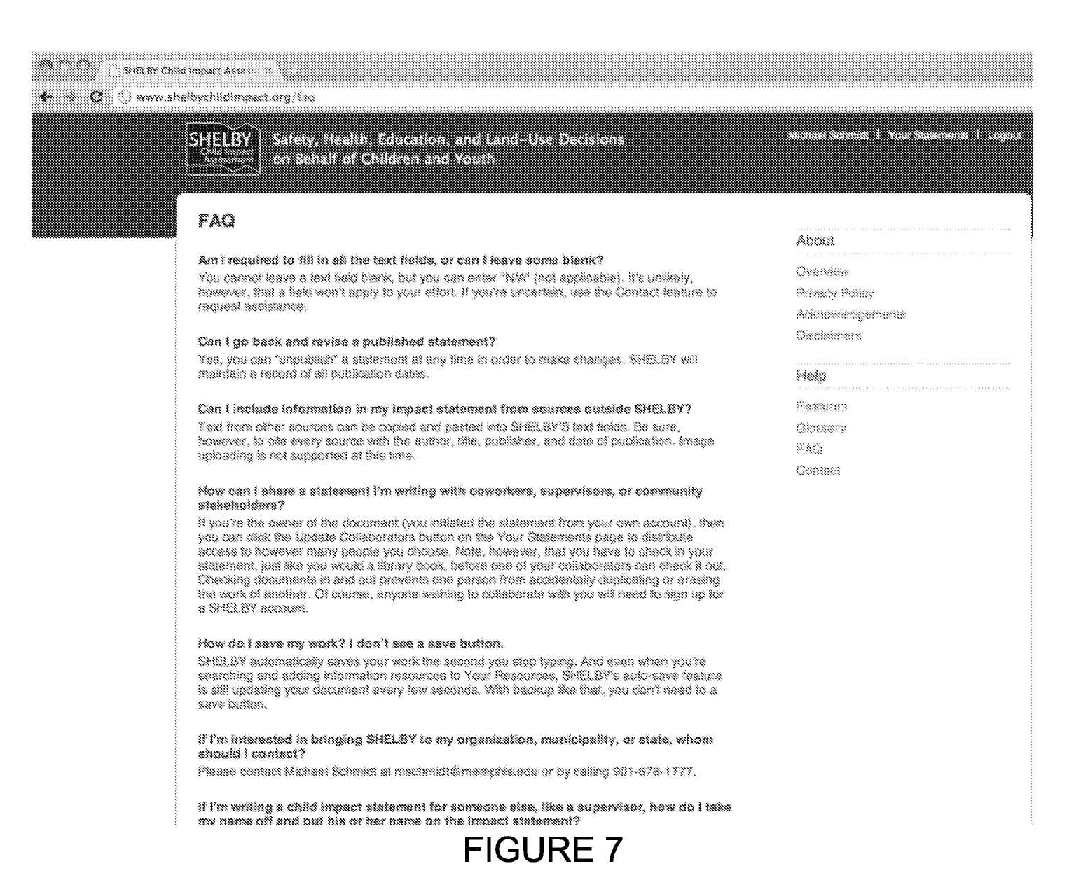

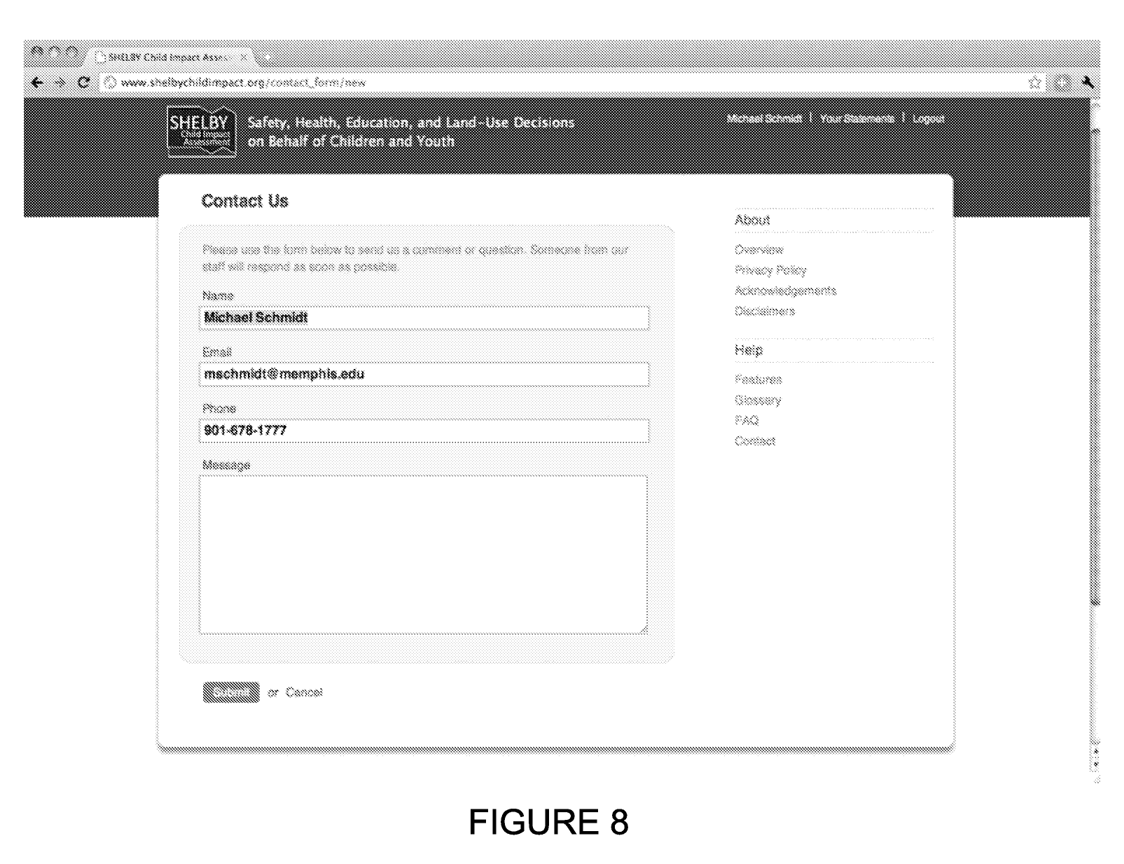

FIGS. 2-3 show an initial web page or pages for an exemplary embodiment of a CISRS. From this page, a user may view an overview page, which may or may not have an introductory video (FIG. 4), or a variety of help pages. Help pages include a features summary page (FIG. 5), a glossary (FIG. 6), a FAQ page (FIG. 7), and a contact form page, which may prompt the user to enter name, email, and other contact information (FIG. 8).

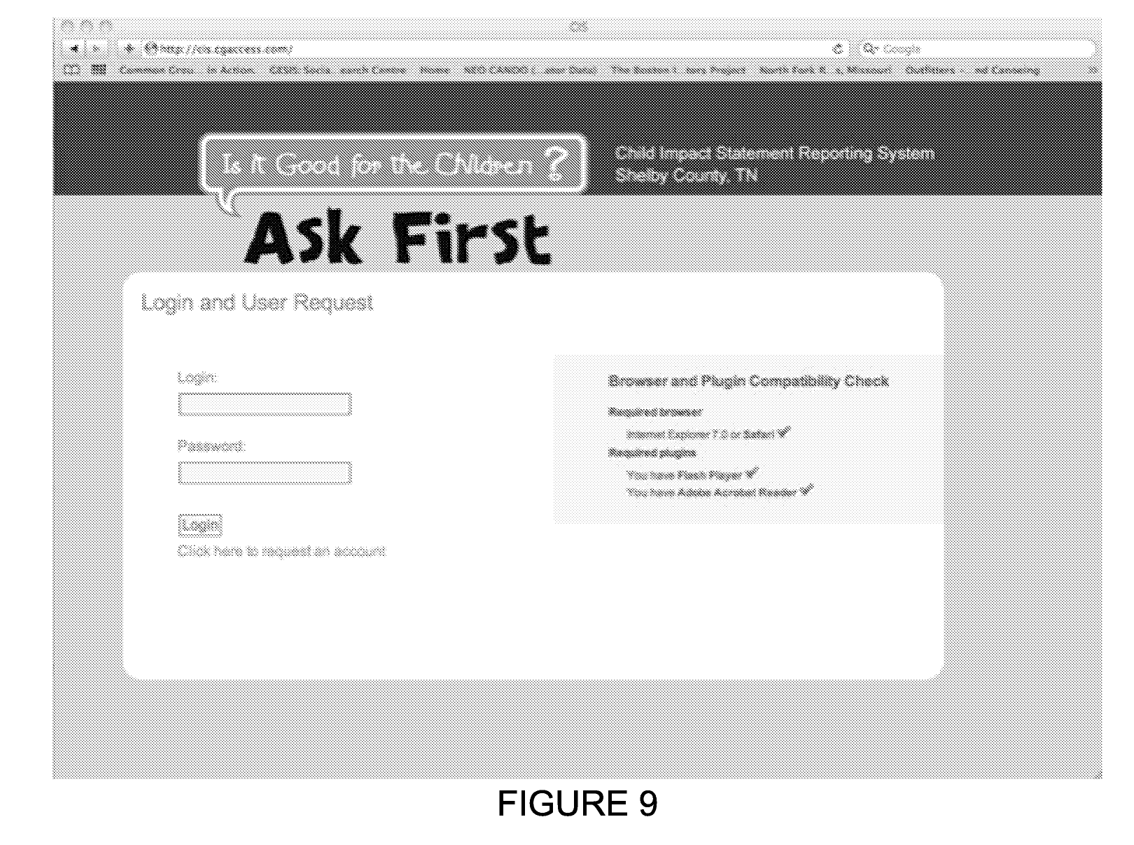

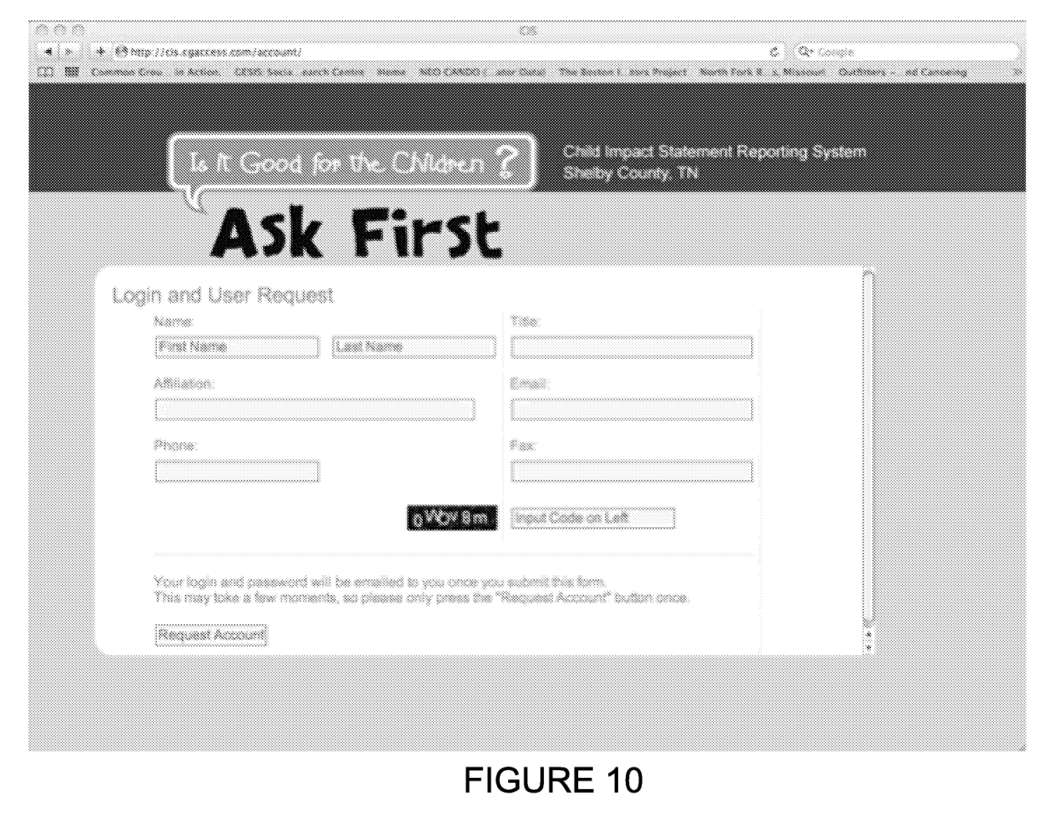

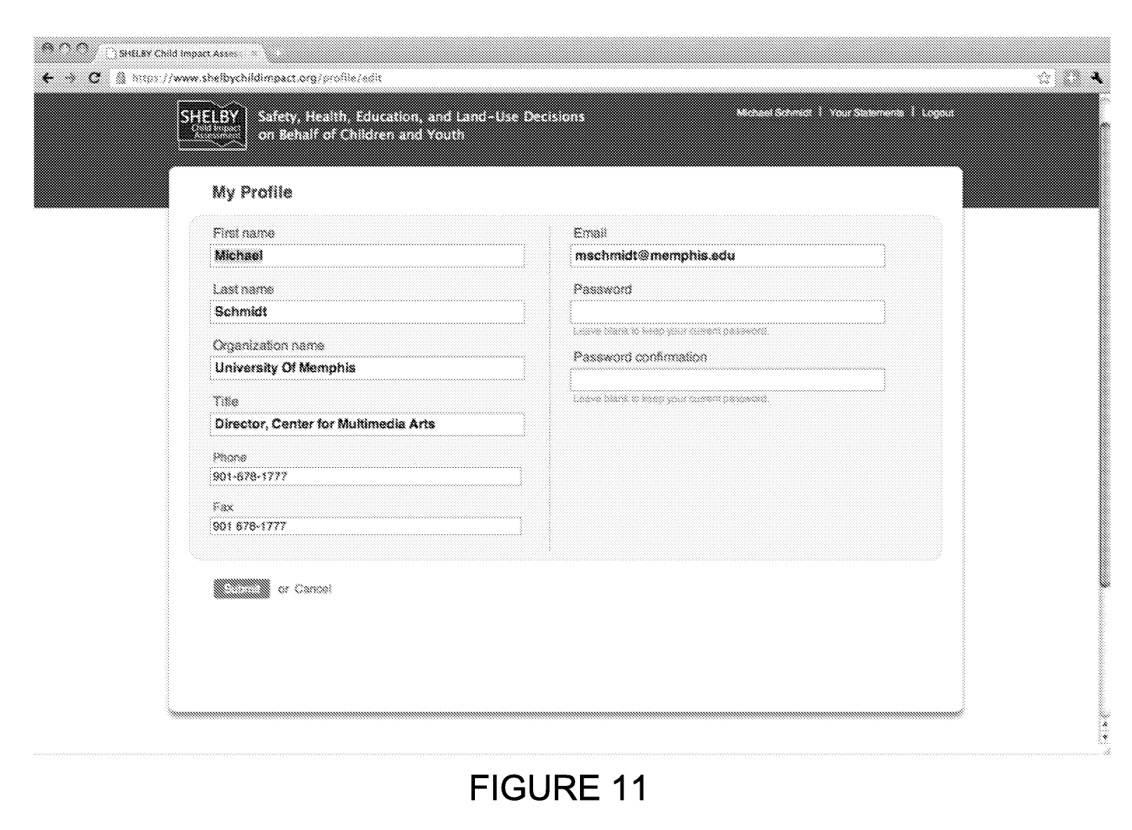

The user may click on the login button or icon to go to the login page. An example of a login page is shown in FIG. 9. If the user does not already have an account login and password, they may request that an account be created, as shown in FIG. 10. The user also may modify their account profile, once an account has been created, as seen in FIG. 11.

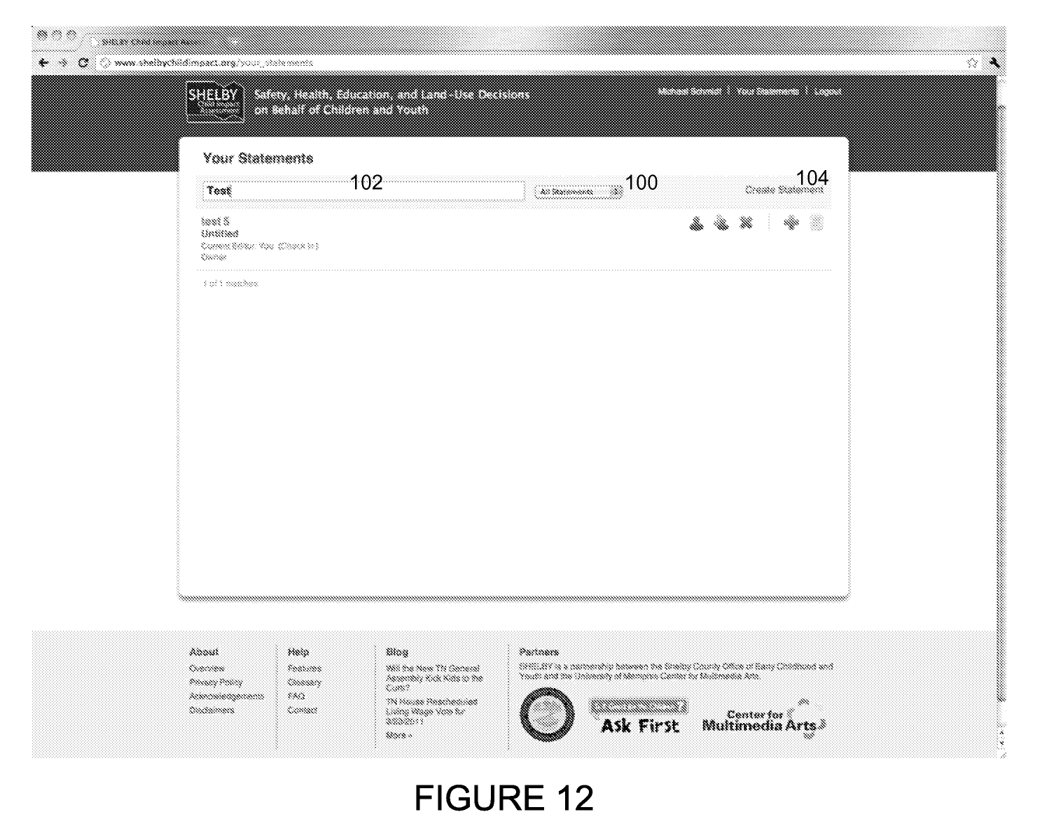

After logging in, the user may create or modify CIS documents. The user may click on the “Your Statements” button or icon to go to a “Your Statements” page, as seen in FIG. 12. From this page, the user may view all of their current statements and CIS documents 100, or may search for particular statements 102. The user also may chose to create a new statement 104.

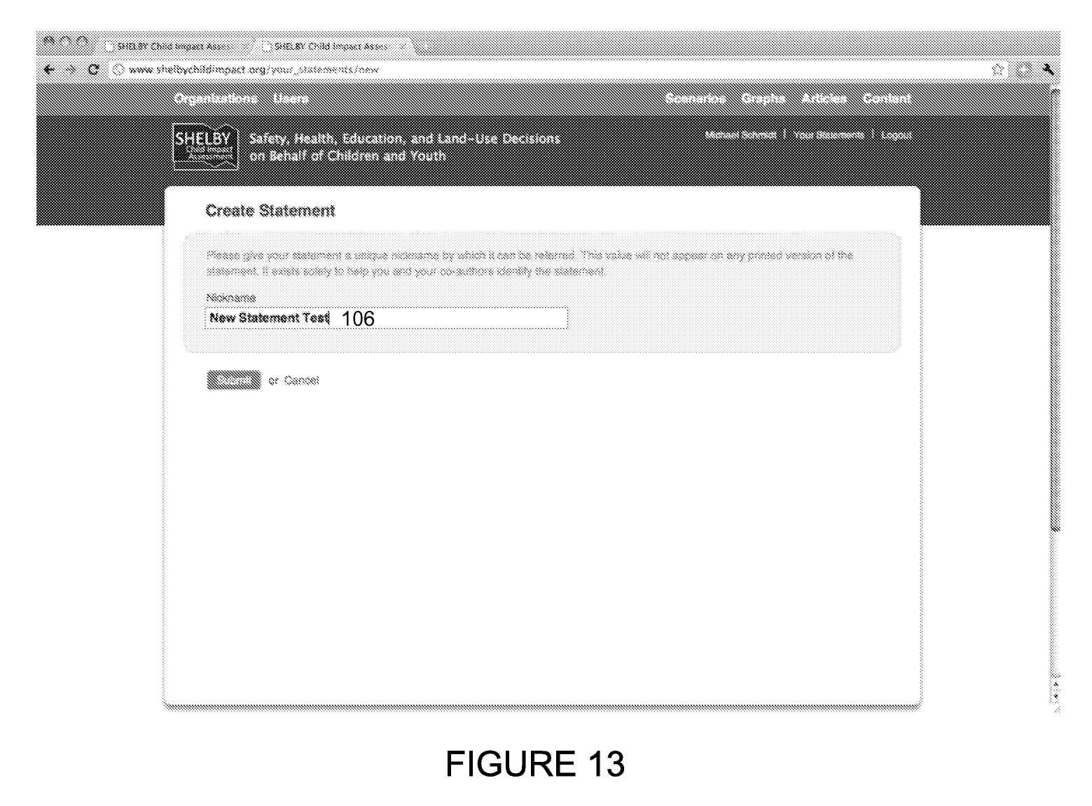

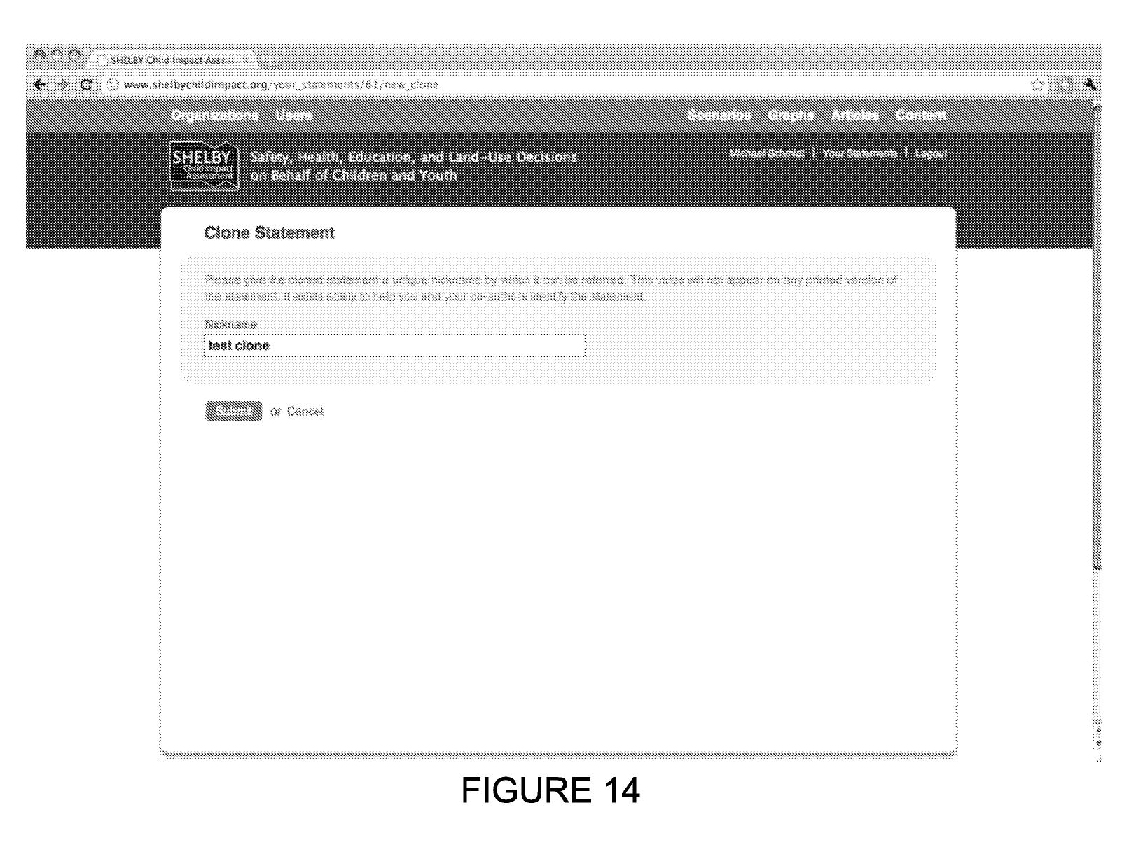

FIG. 13 shows an example of a “Create Statement” page, which initiates the process for creating a statement. The user is prompted to enter a name or “nickname” 106 for the statement for ease of reference. The user also may chose to “clone” an existing statement to accelerate the statement creation process, as seen in FIG. 14.

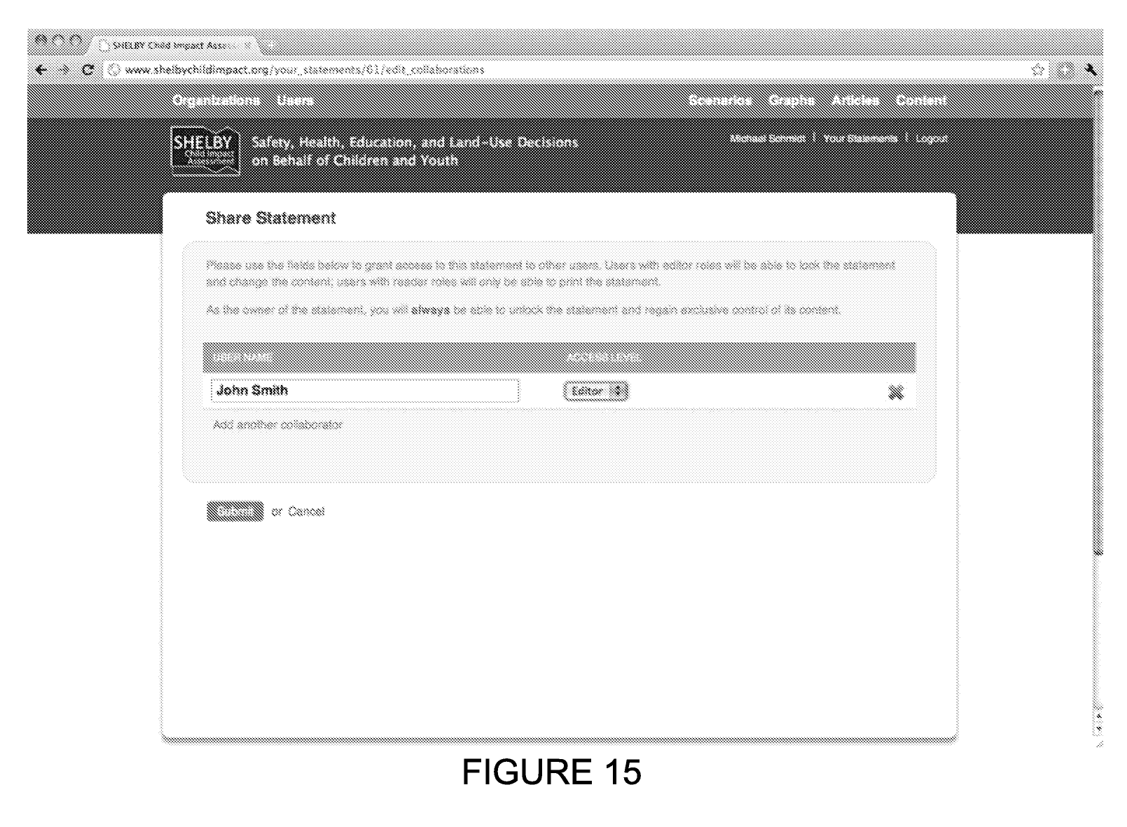

The user that creates the statement may set access levels to the statement for other users through the “Share Statement” page. An example of such a page is shown in FIG. 15, which prompts the user to enter the other user's name and access level. Access levels include, but are not limited to, editor roles (able to lock the statement and change content) and reader roles (able to access and print the statement).

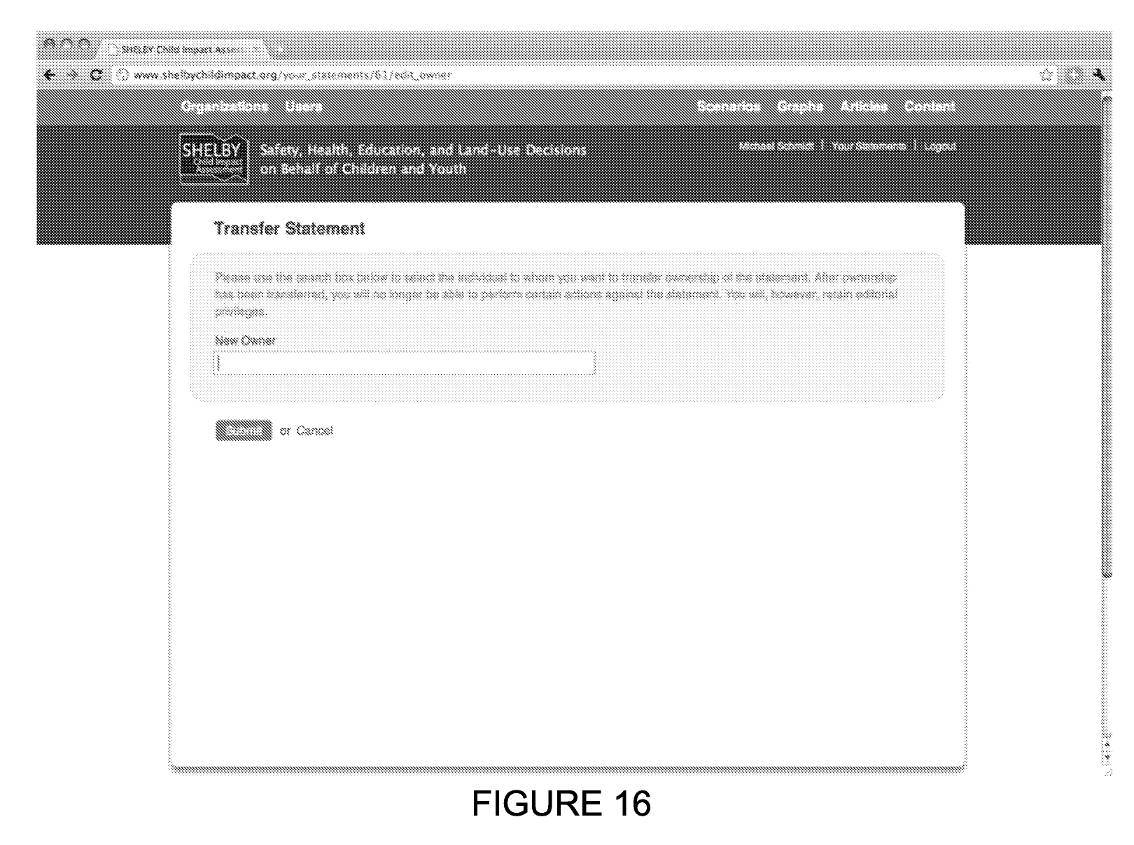

A user that creates a statement is considered the owner of the statement, and will be able to unlock the statement, regardless of who locked it, and regain exclusive control of the statement content. The owner-user may transfer ownership of the statement to another user through the “Transfer Statement” page, as shown in FIG. 16. After ownership has been transferred, the former owner may be dropped to an editor access role.

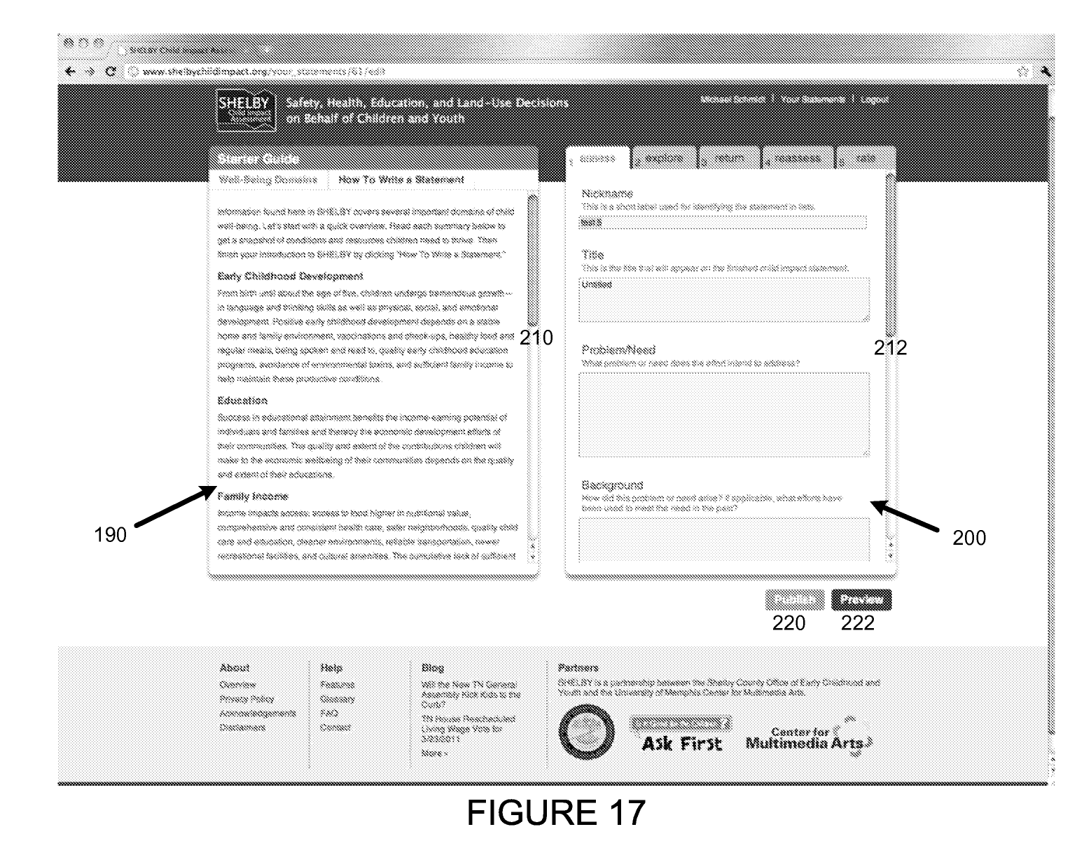

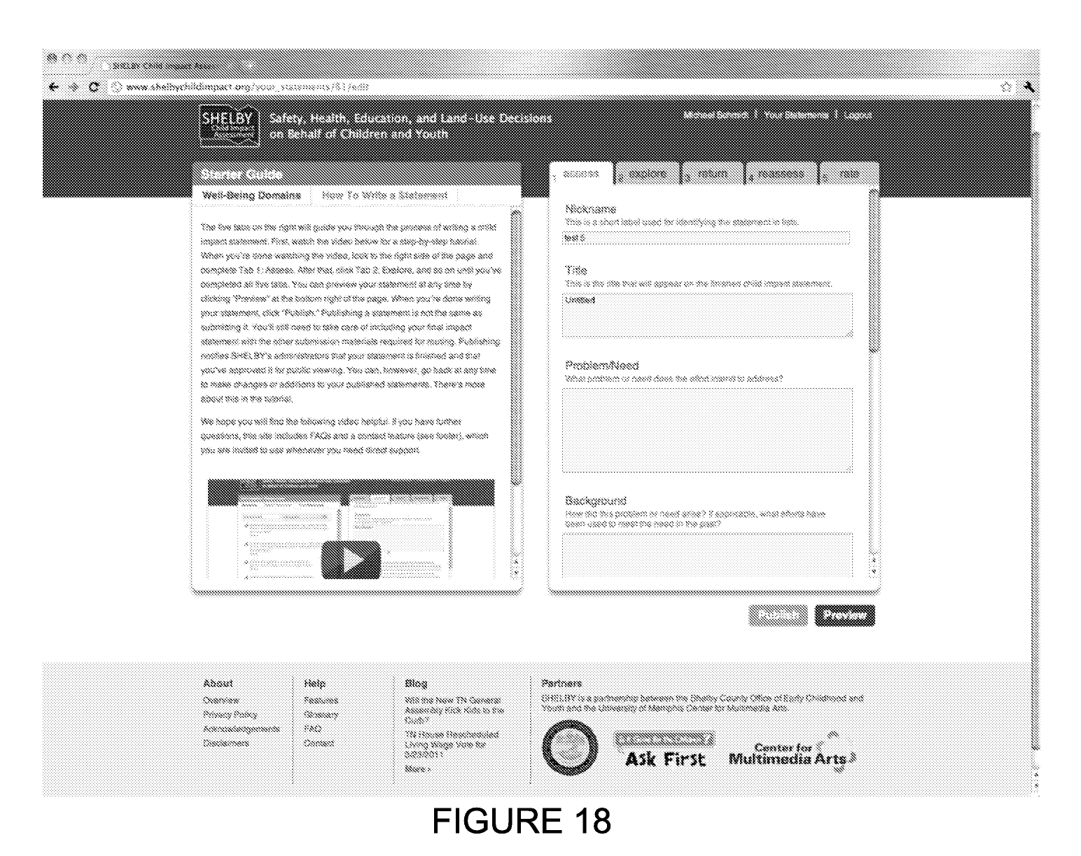

FIGS. 17 and 18 show an example of a user interface for the creation of the statement content. In this embodiment, the interface is divided into an information window 190 and an input window 200. The input window has five tabs reflecting the statement creation process. In this embodiment, the tabs are labeled “assess,” “explore,” “return,” “reassess,” and “rate.” The content of the information window depends in part upon the tab selected in the input window. Bars or buttons 210,212 may be used to scroll through the information or items shown in each window. For example, FIG. 17 shows the text of the top section of a “Starter Guide: Well-Being Domains” text.

Selecting the “How to Write a Statement” tab at the top of the information window in FIG. 17 changes the information window display to that shown in FIG. 18. This section provides basic information on the process of writing a statement, including a video presentation.

In general, the statement creation process follows the sequence of the five tabs on the input window. Initially, under the “assess” tab, the user is prompted to enter a nickname for the statement, the title of the statement (i.e., as it will appear on the completed, published statement), a description of the problem or need, and the background of the problem or need. The “assess” tab may request other input items, as well. After completing the “assess” tab, the user clicks the other tabs, generally in sequence, and completes them in turn until completing all five tabs. The user can preview the statement at any time by clicking the “Preview” button 220. When the statement is completed, the user can click “Publish” to notify the system administrators that the statement is substantially completed and approved for public viewing. However, a published statement can still be changed, modified, or added to prior to actual submission.

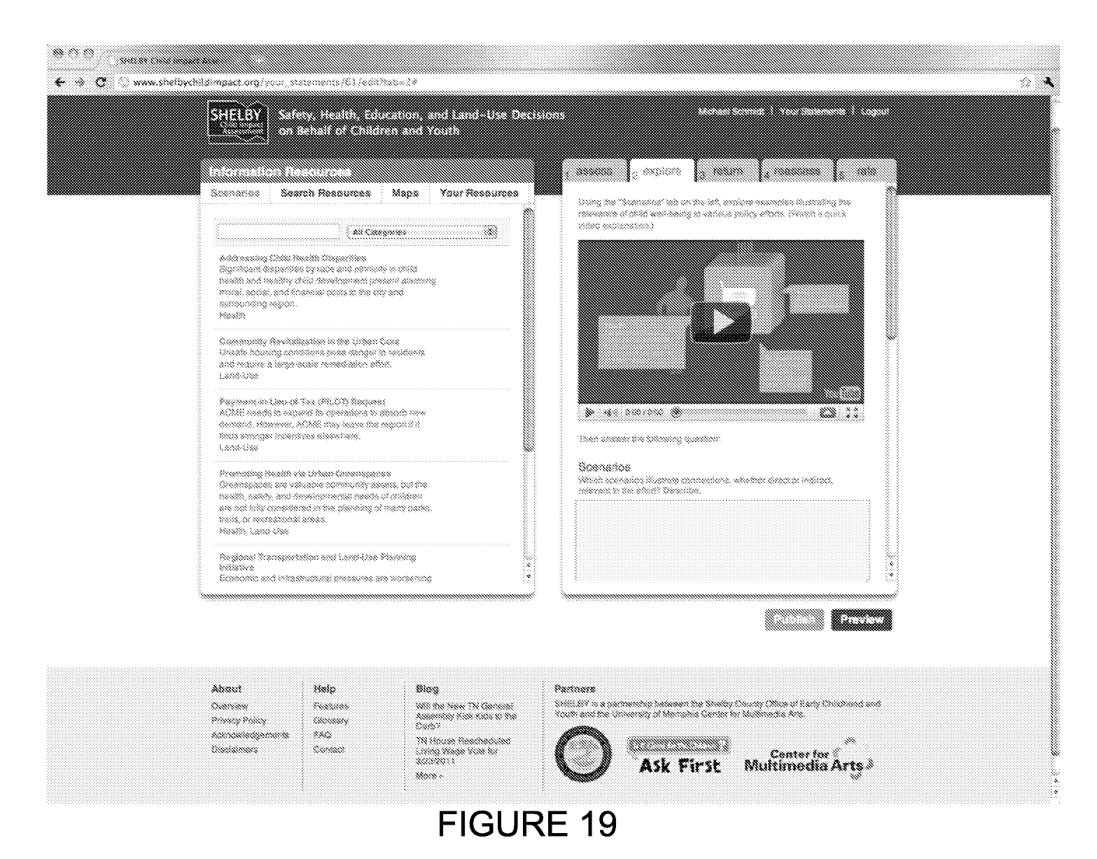

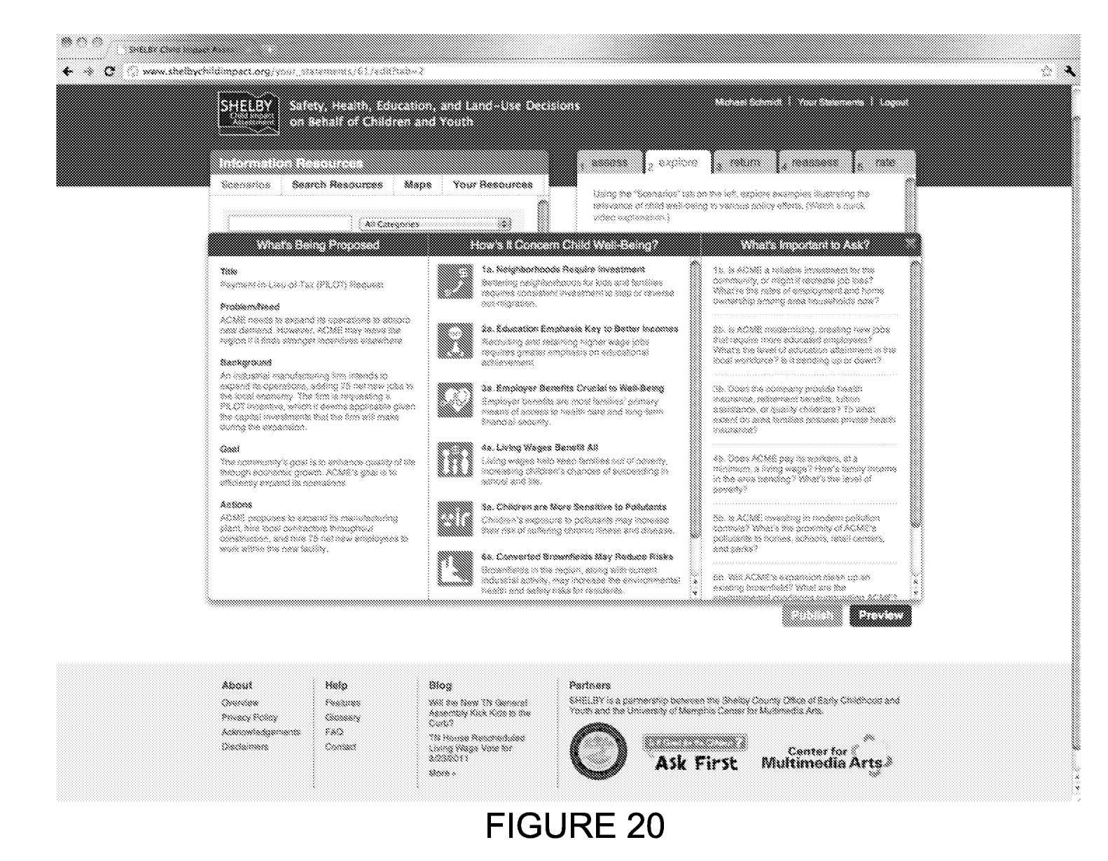

FIG. 19 shows the “explore” tab, which prompts the user to enter scenario information, and may provide a graphic or video information display. The information window in this view has four tabs: scenarios, search resources, maps, and your resources. FIG. 19 shows the scenario tab, which displays a list of possible scenarios for the user to select. Selecting one of these scenarios (by, for example, clicking on the title), causes a window to display, showing more detailed information about that scenario, including a list of possible questions for the user 250. FIG. 20 shows an example of such a window for the “Payment-in-Lieu-of-Tax (PILOT) Request” scenario.

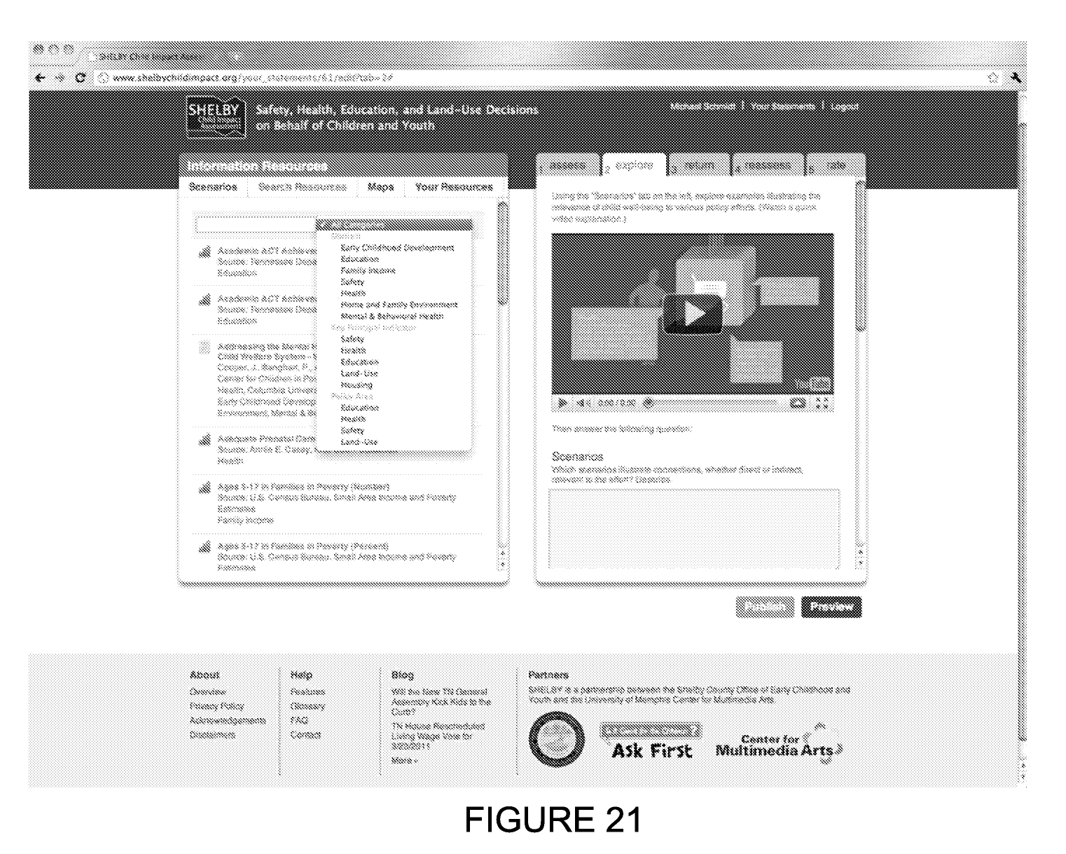

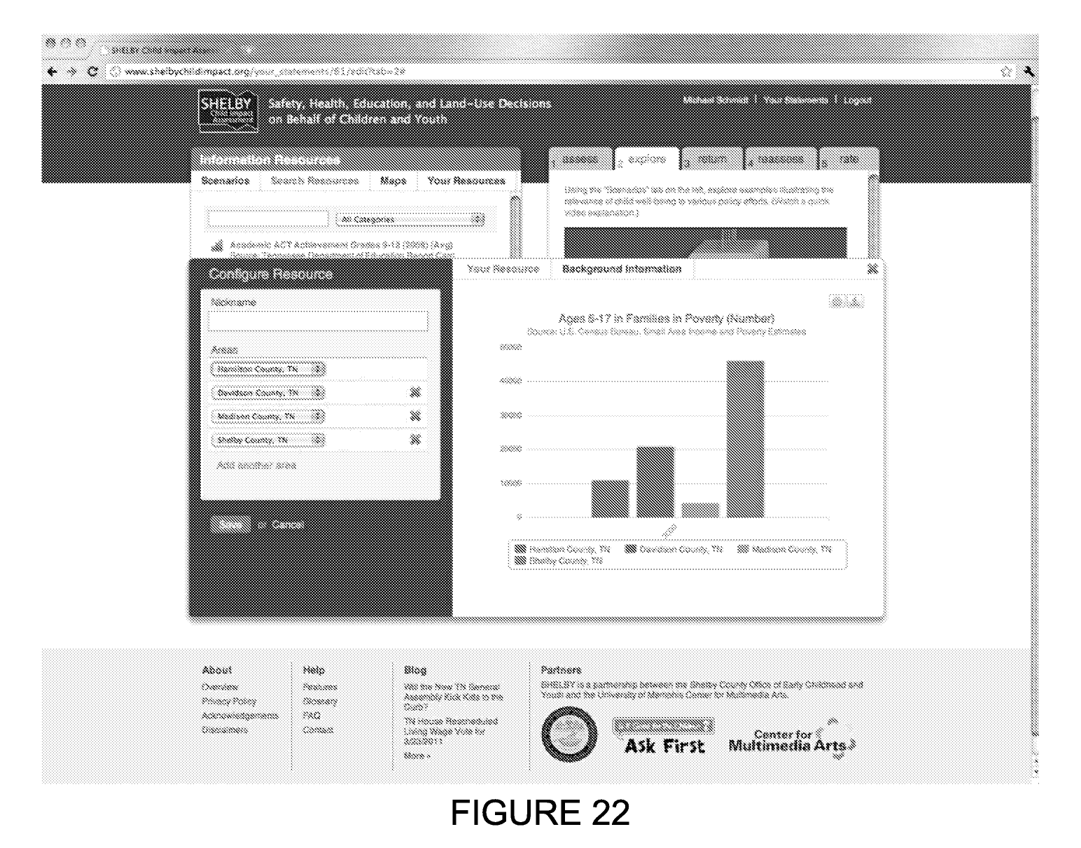

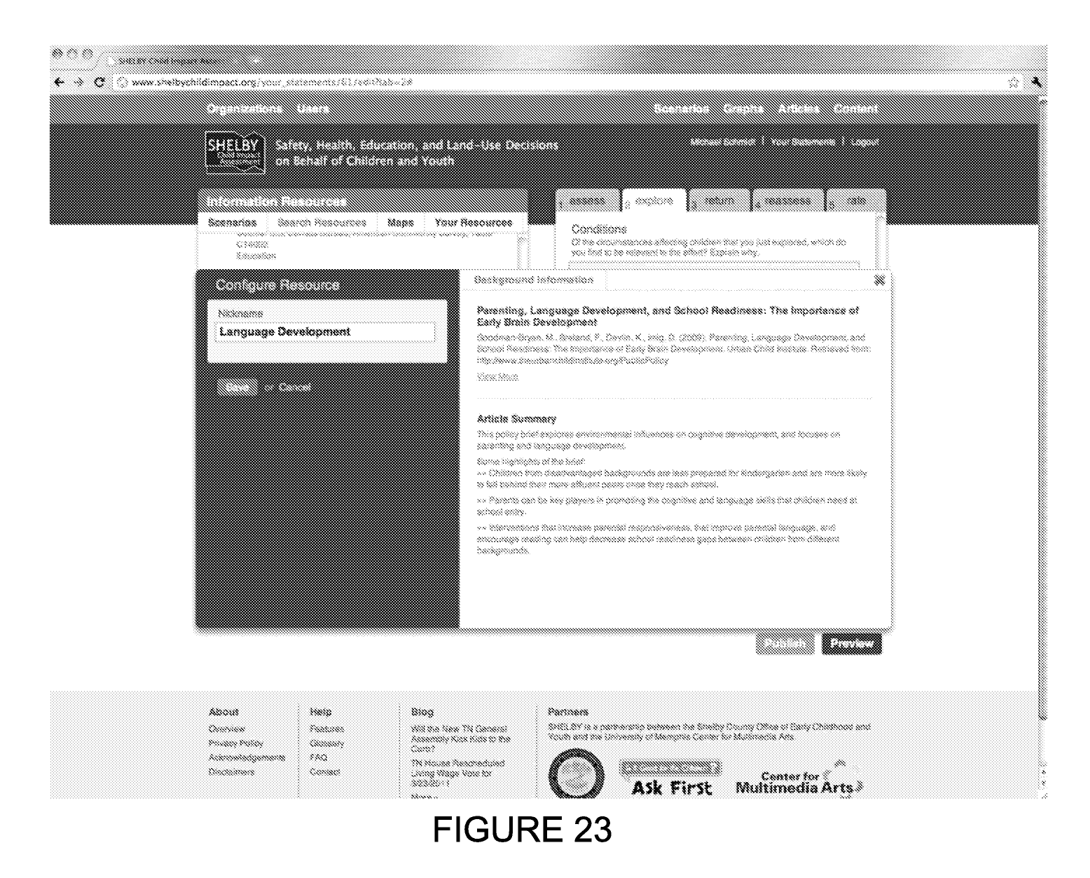

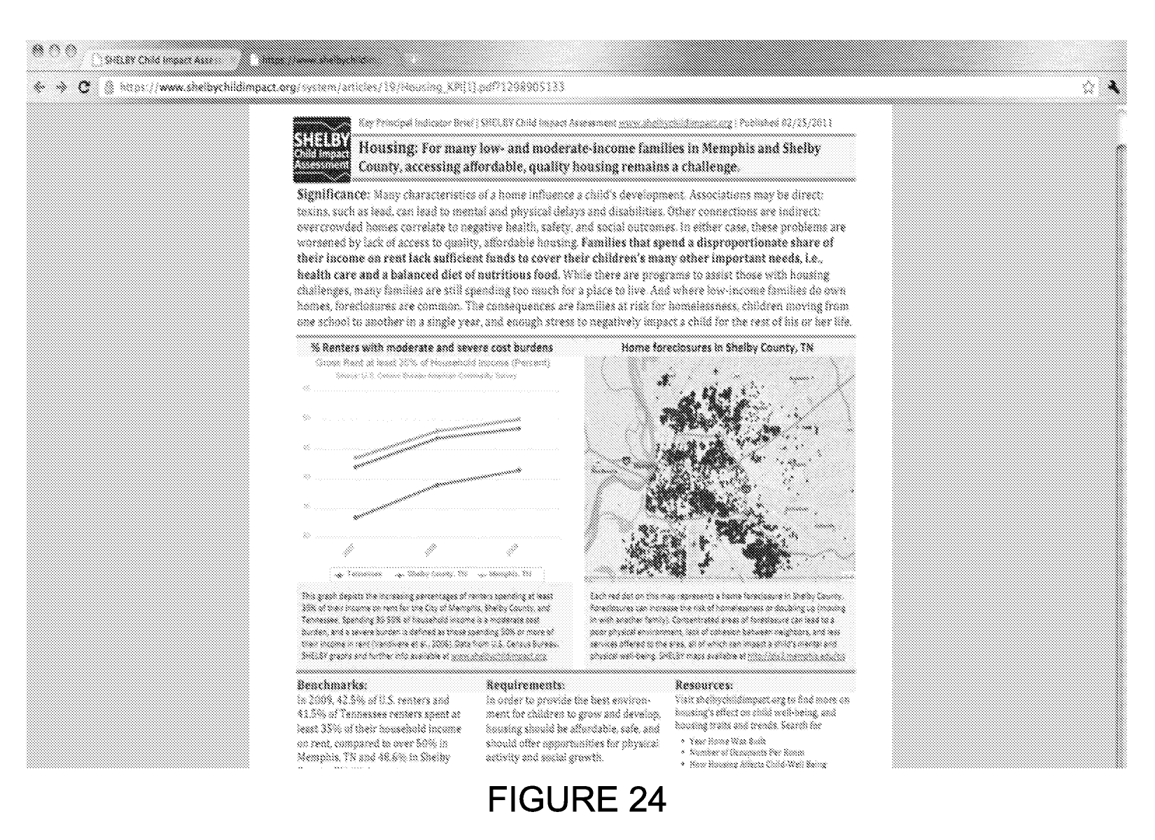

FIG. 21 shows the search resources tab selection, which allows the user to search for and view a variety of resources in different areas. As seen in FIG. 22, some of the resources may be configured by the user, such as poverty population charges for selected counties or other areas. A user may apply a nickname to the resource for ease of reference. FIG. 23 shows an example of a resource comprising an article summary, and FIG. 24 shows an example of a resource comprising a brief.

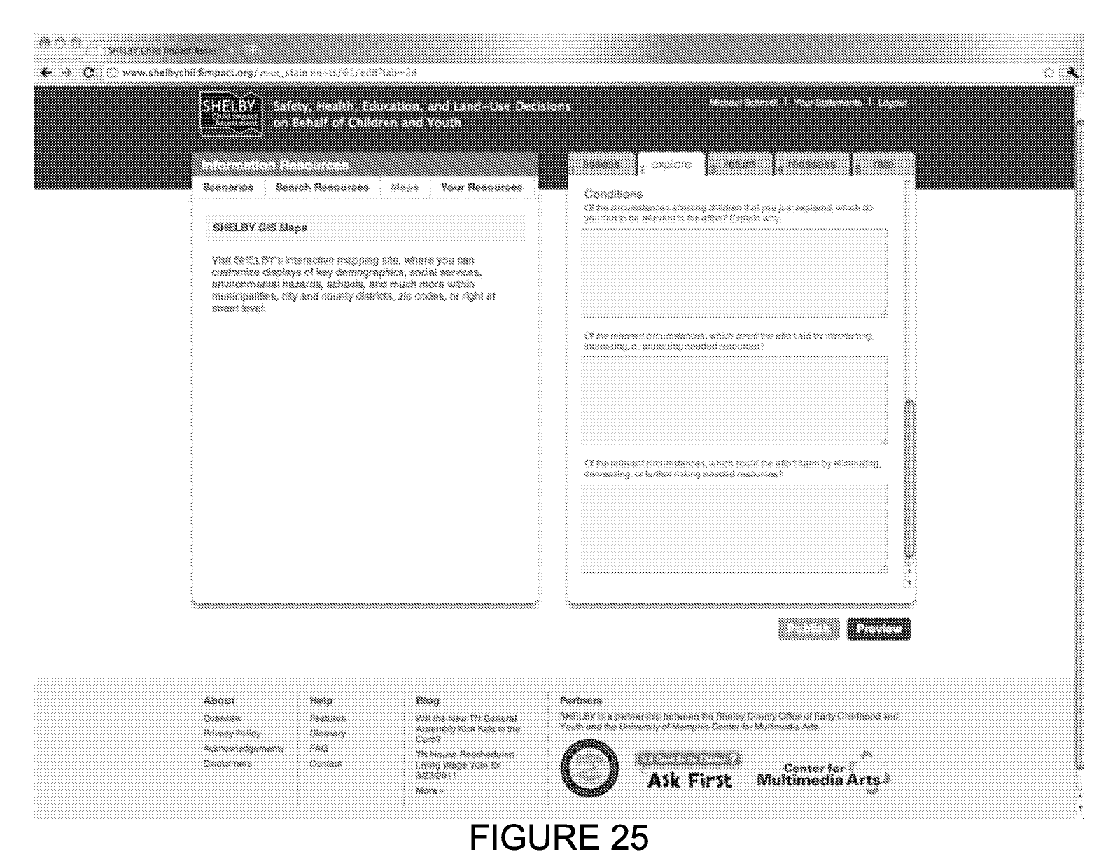

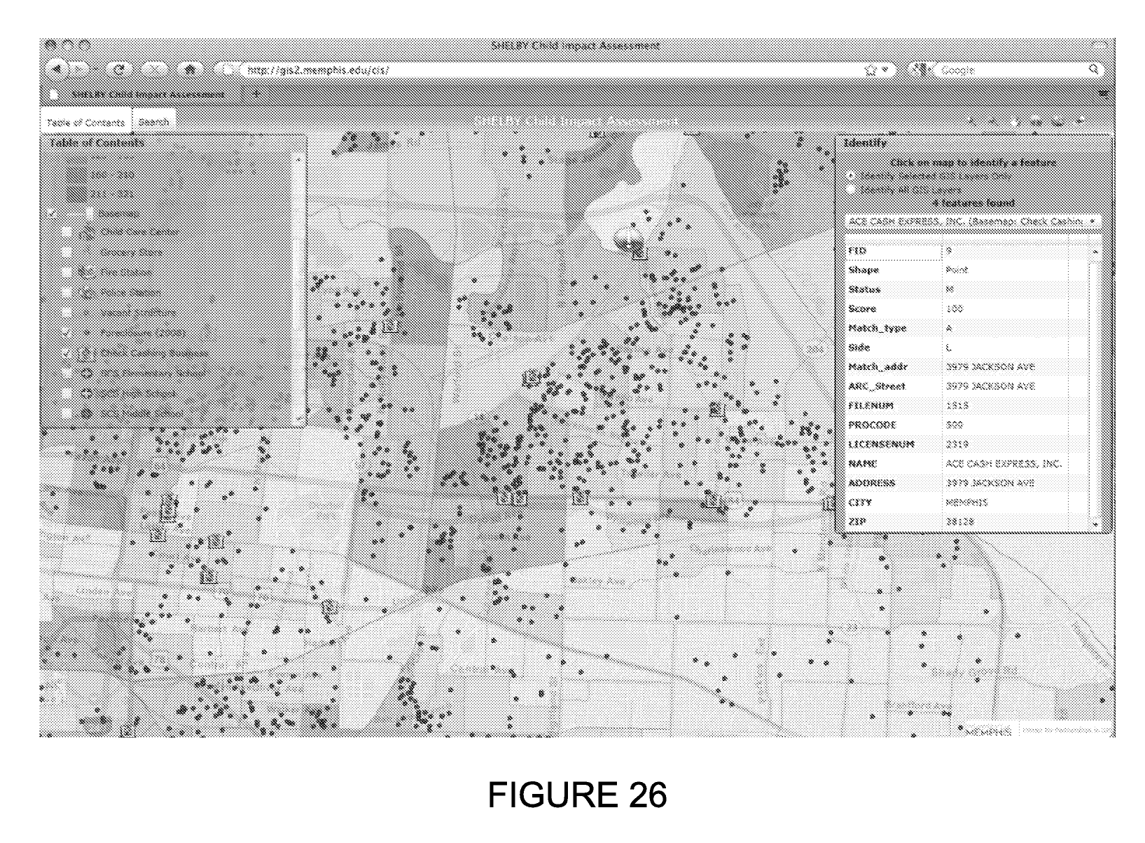

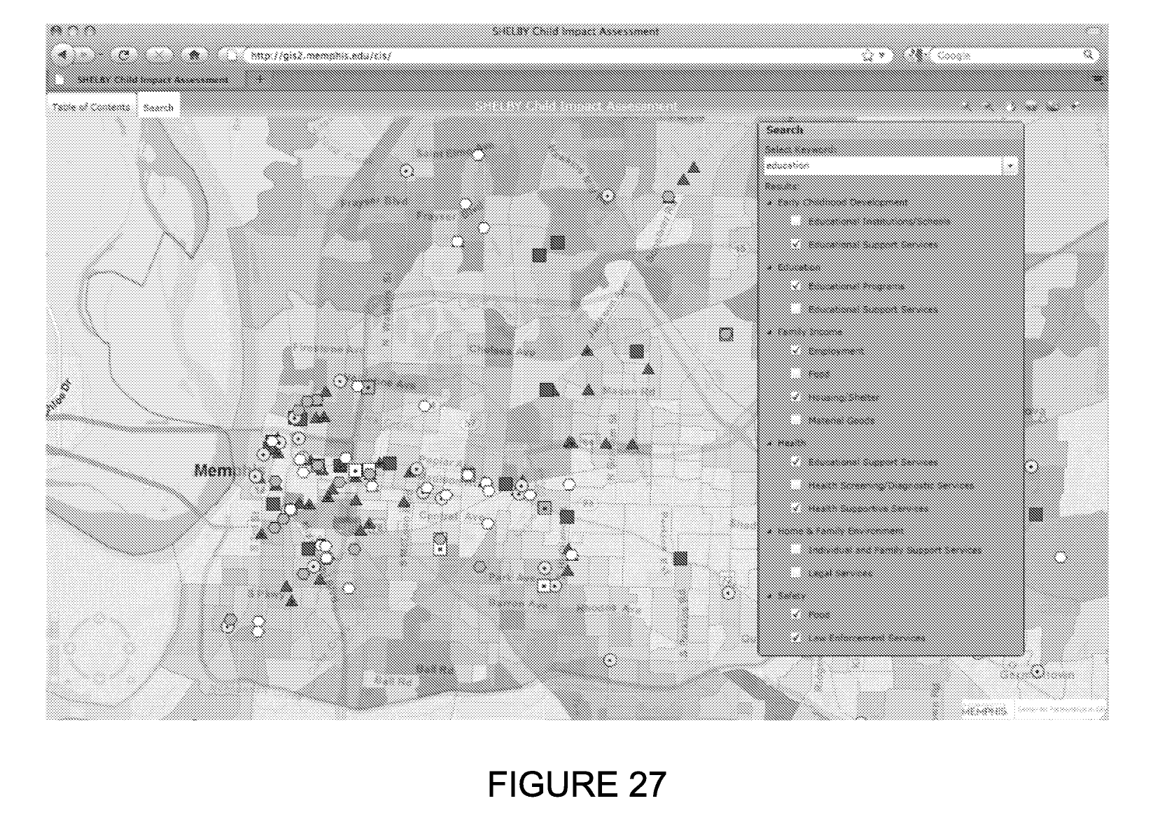

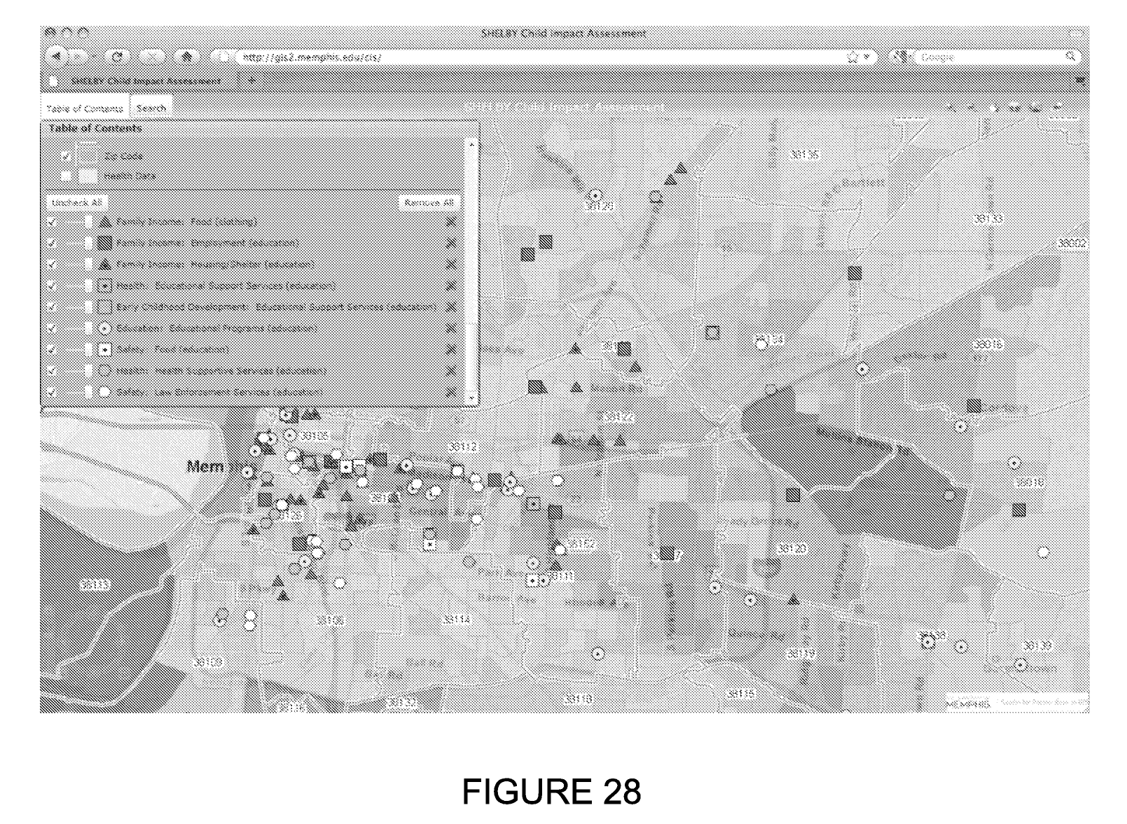

FIG. 25 shows the maps tab, which provides an interface to the system's interactive mapping site, where the user can customize displays of key demographics, social services, environmental hazards, schools, and other information within municipalities, city districts, county districts, zip codes, street level, or other areas. FIGS. 26-28 show examples of customized maps.

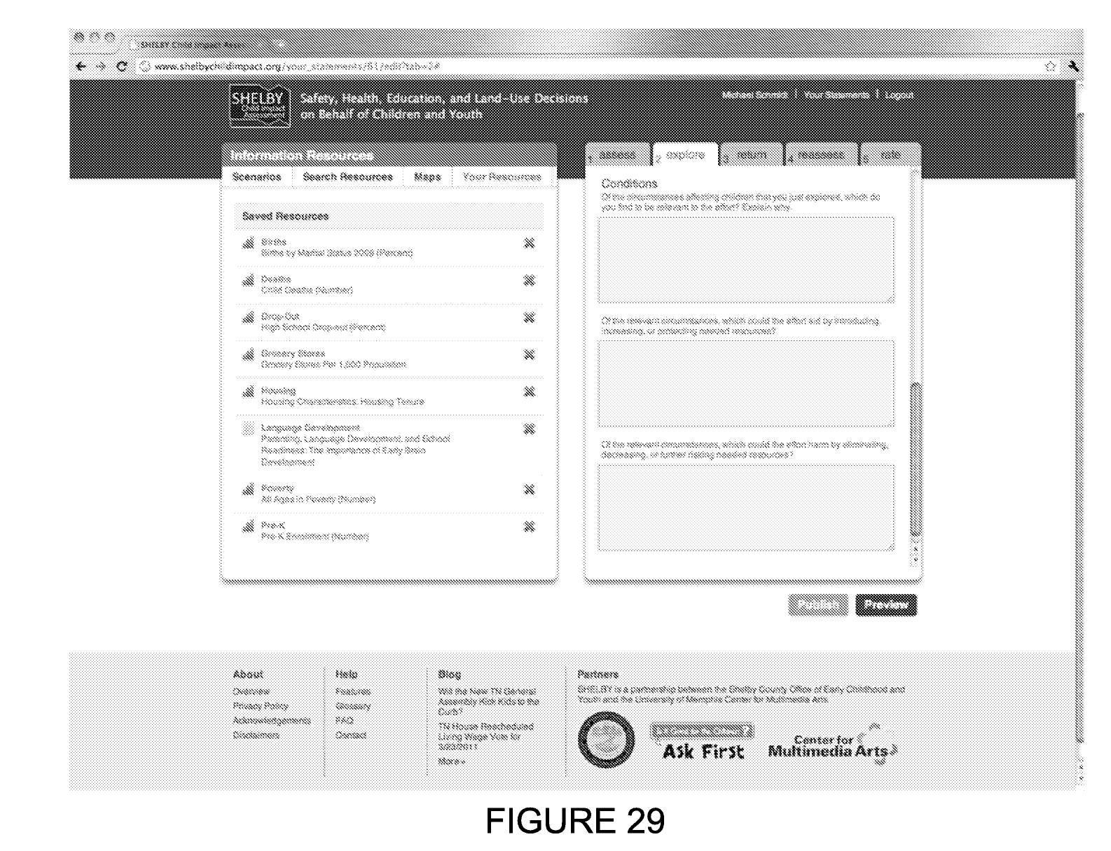

FIG. 29 shows the “your resources” tab, which lists a variety of saved resources.

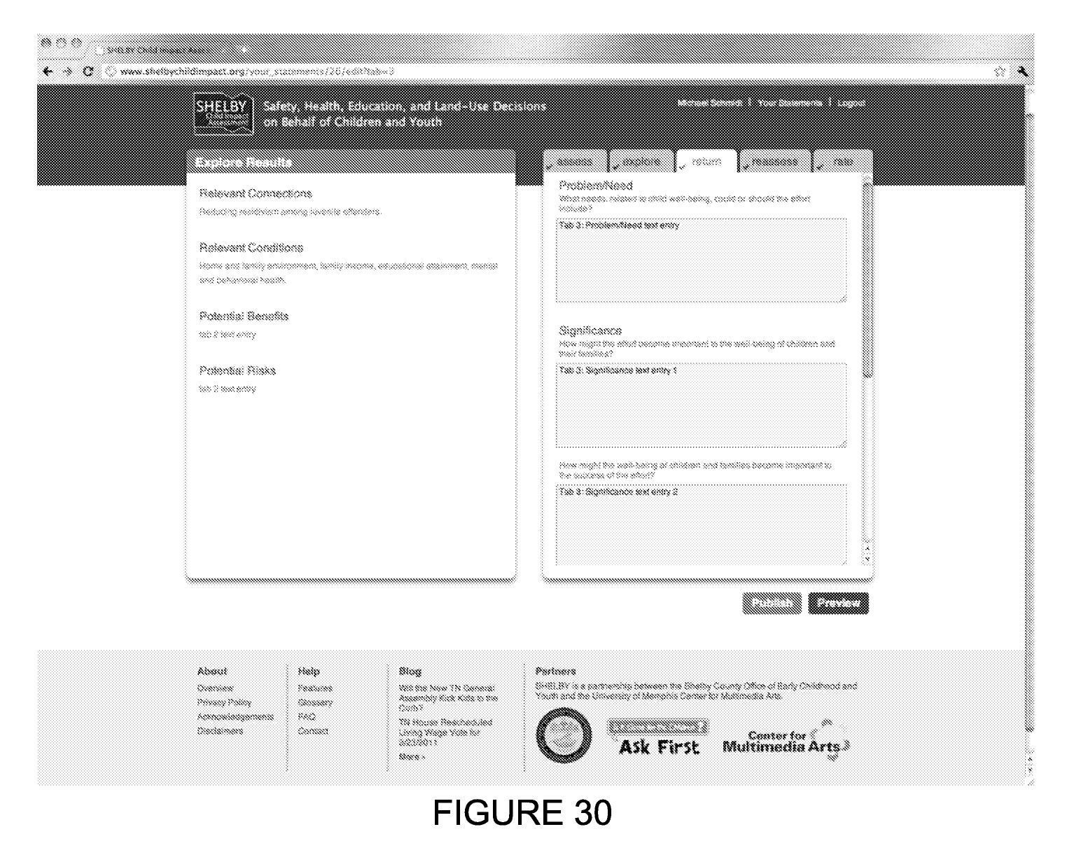

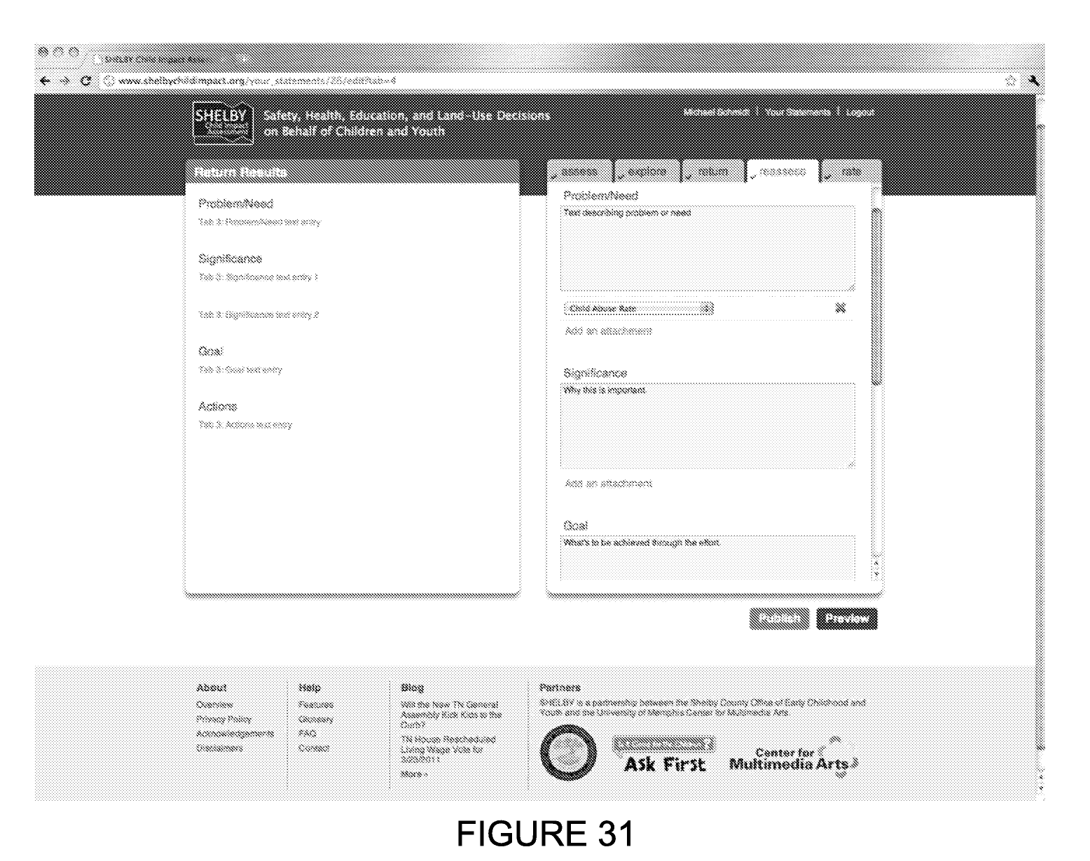

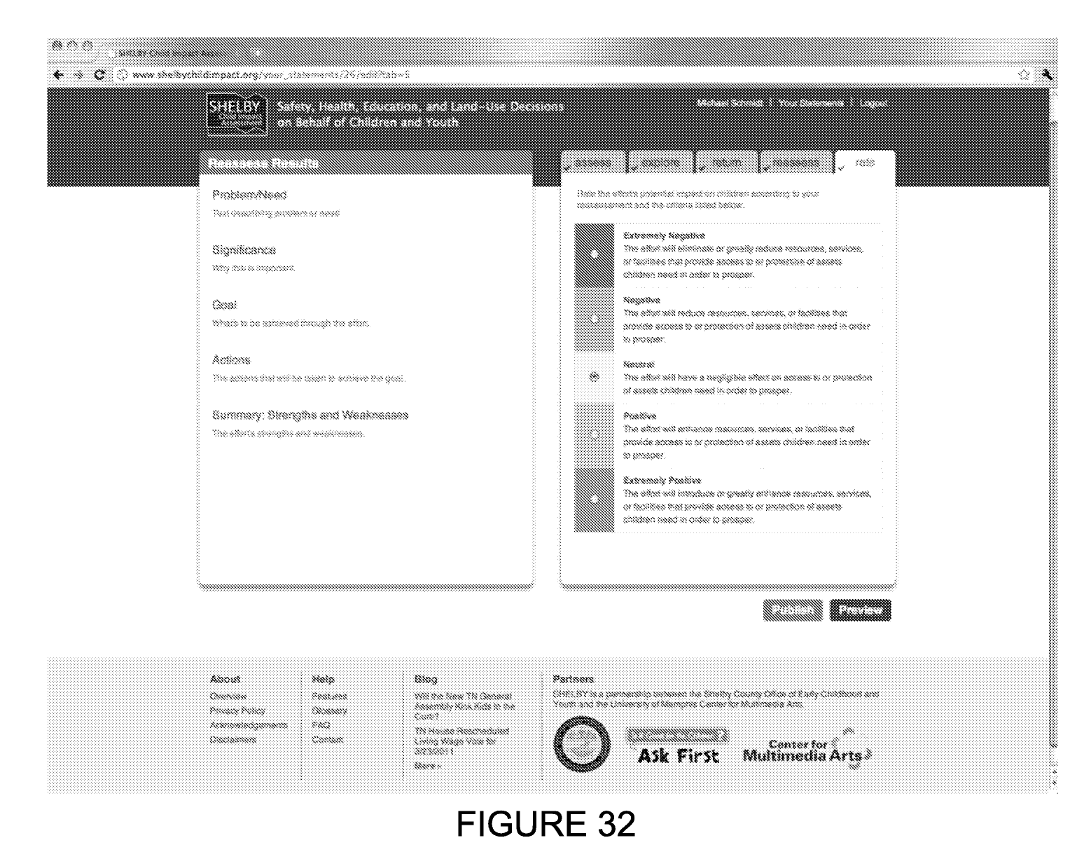

FIG. 30 shows the “return” tab in the input window, which prompts the user to input a text entry for problems or needs, text entries for significance, a text entry for goals, and a text entry for actions. FIG. 31 shows the “reassessment” tab selected, and FIG. 32 shows the “rate” tab. For the latter, the user is prompted to rate the effort's potential impact on children according to the reassessment and certain listed criteria.

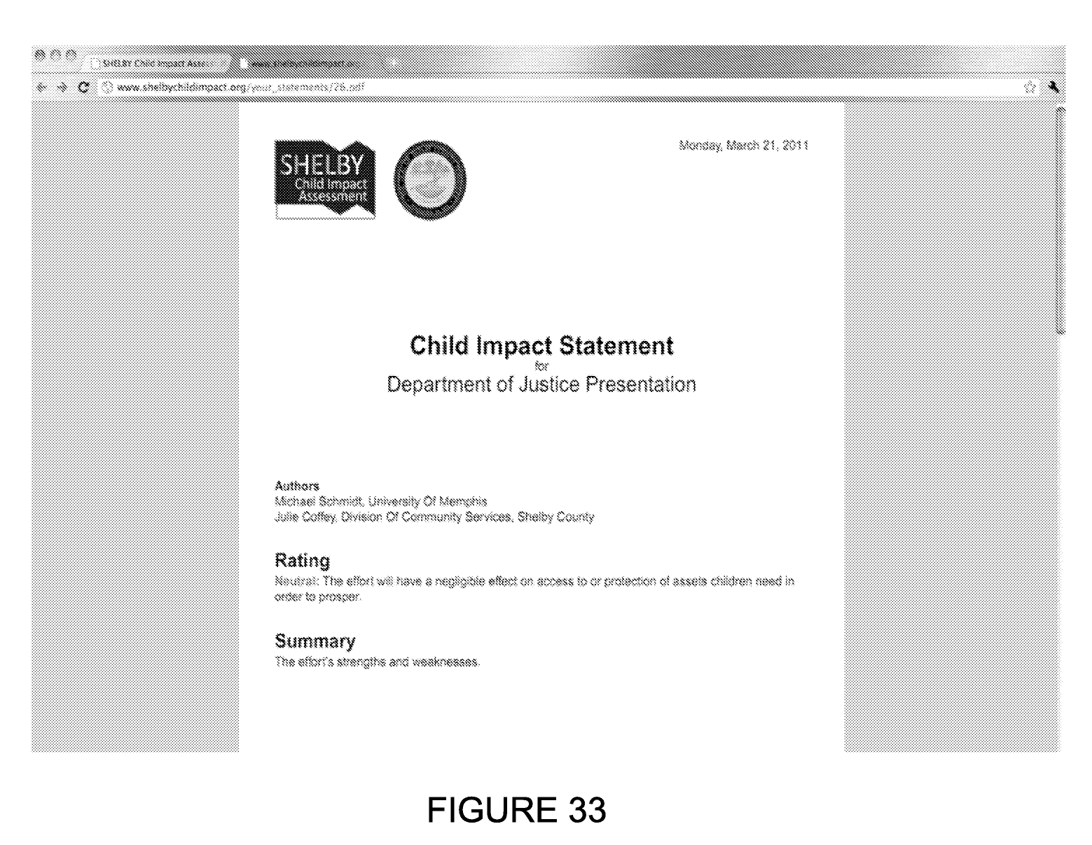

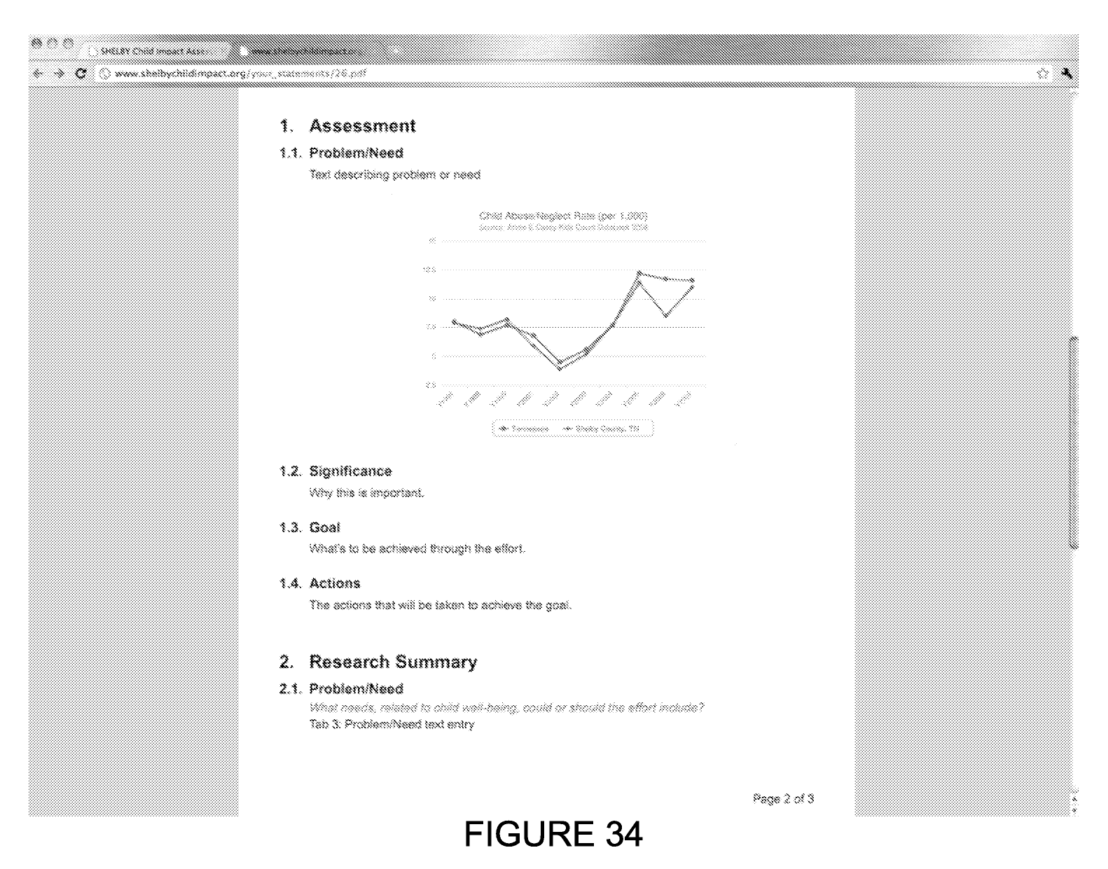

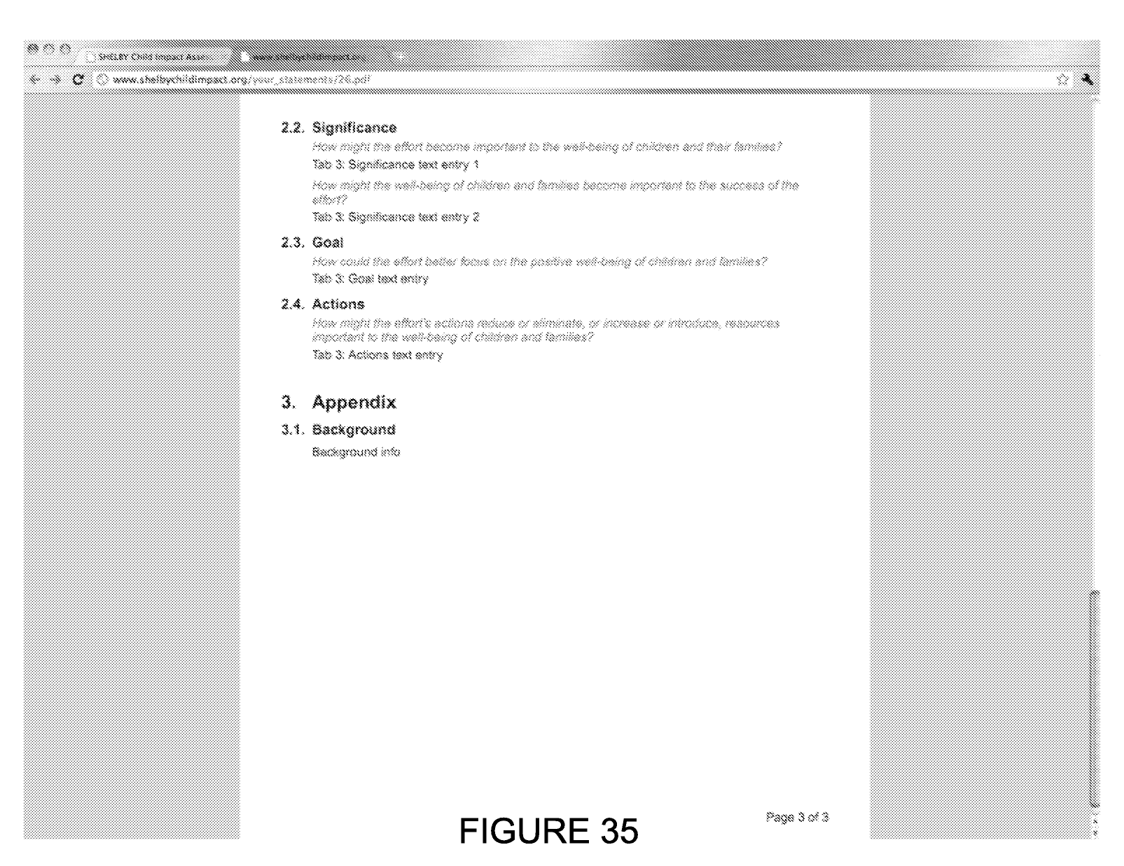

FIGS. 33-35 show an example of a CIS outline. The process described above is used to fill in the various entries, as indicated.

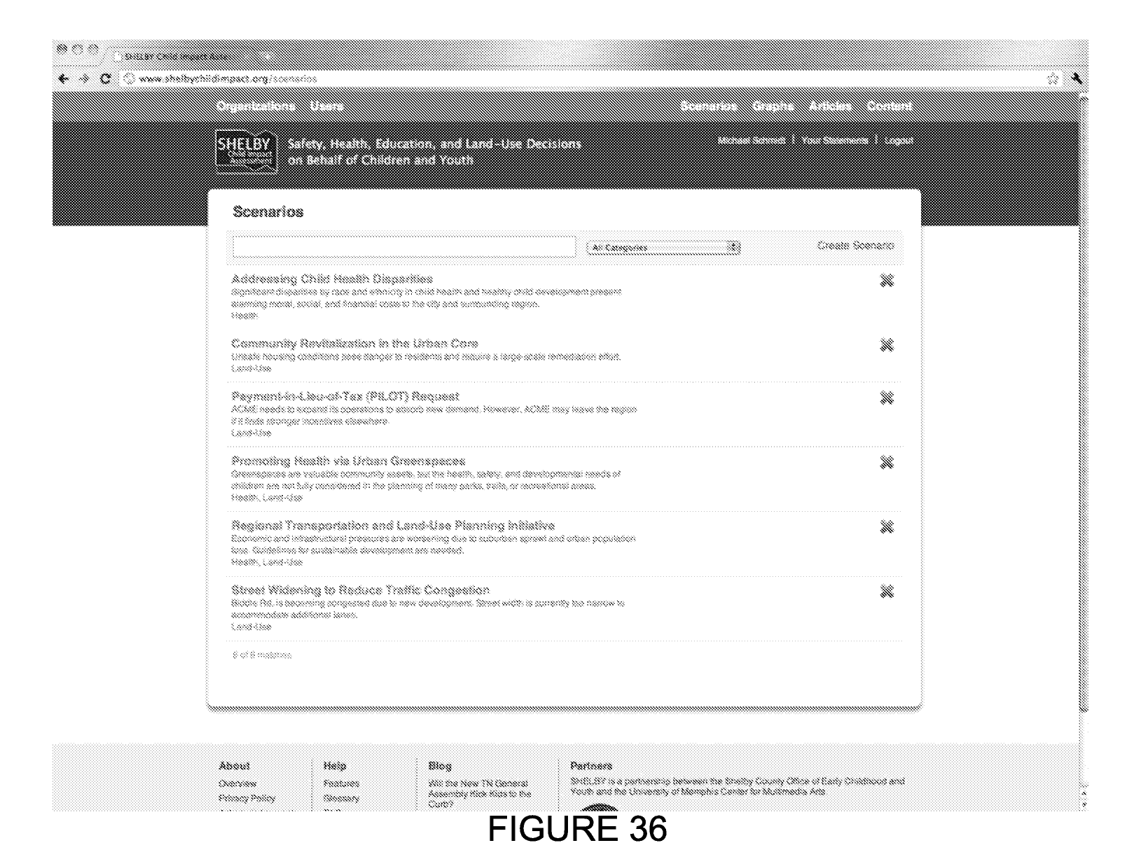

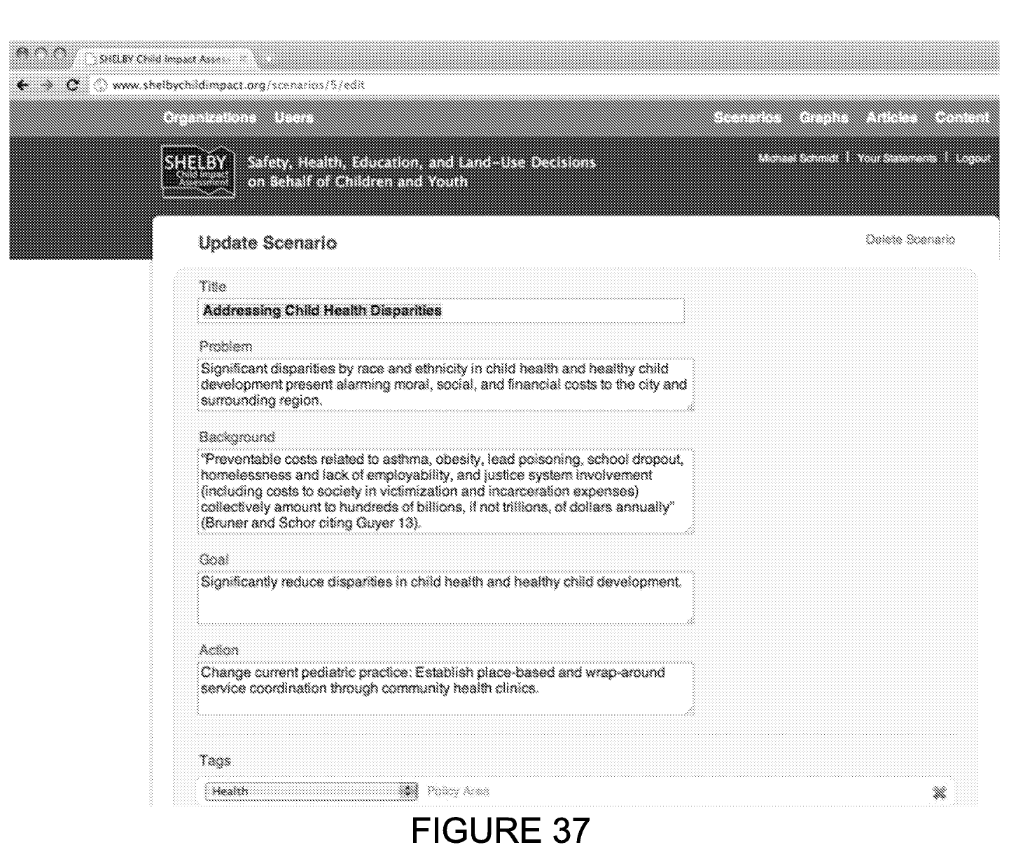

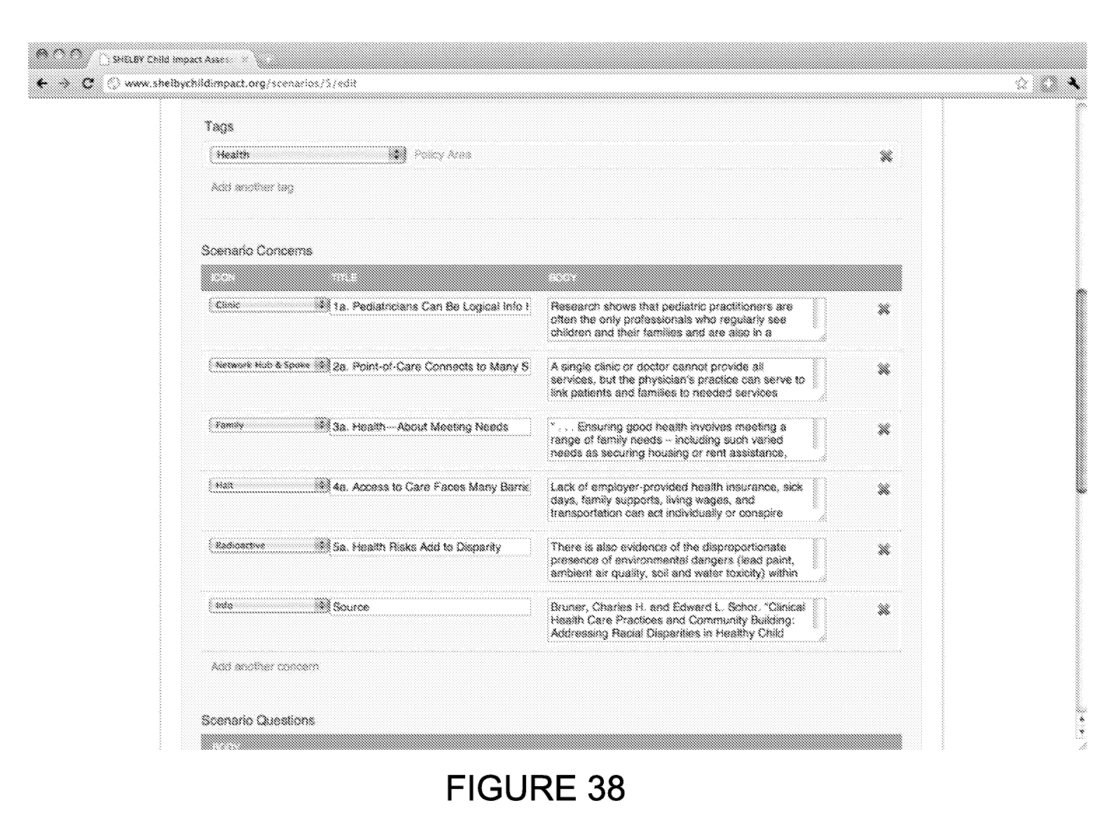

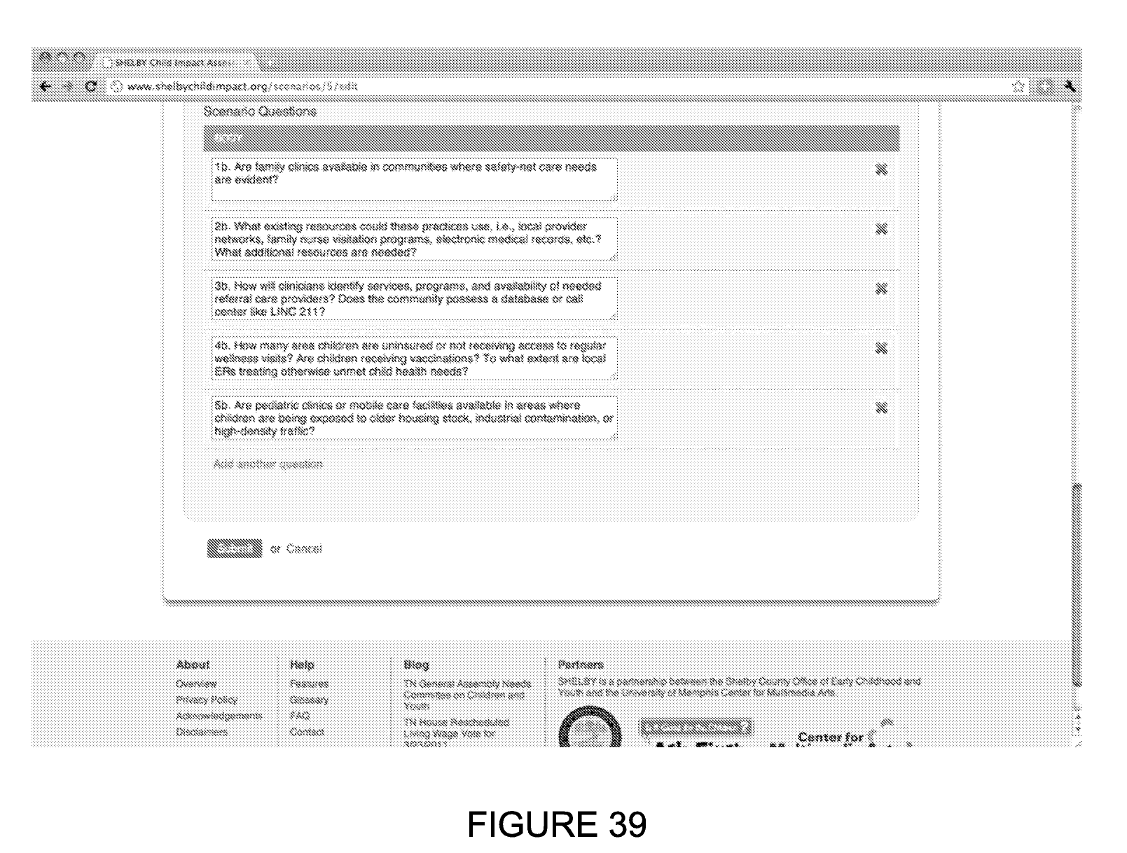

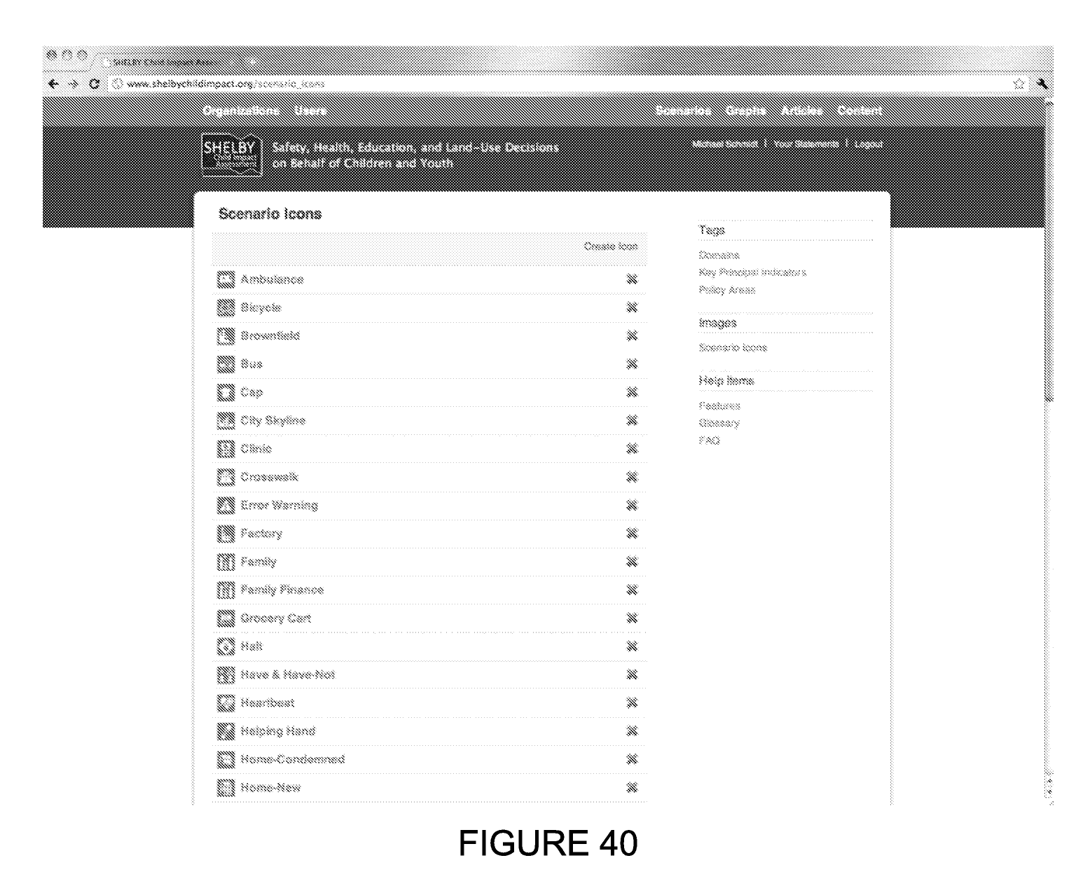

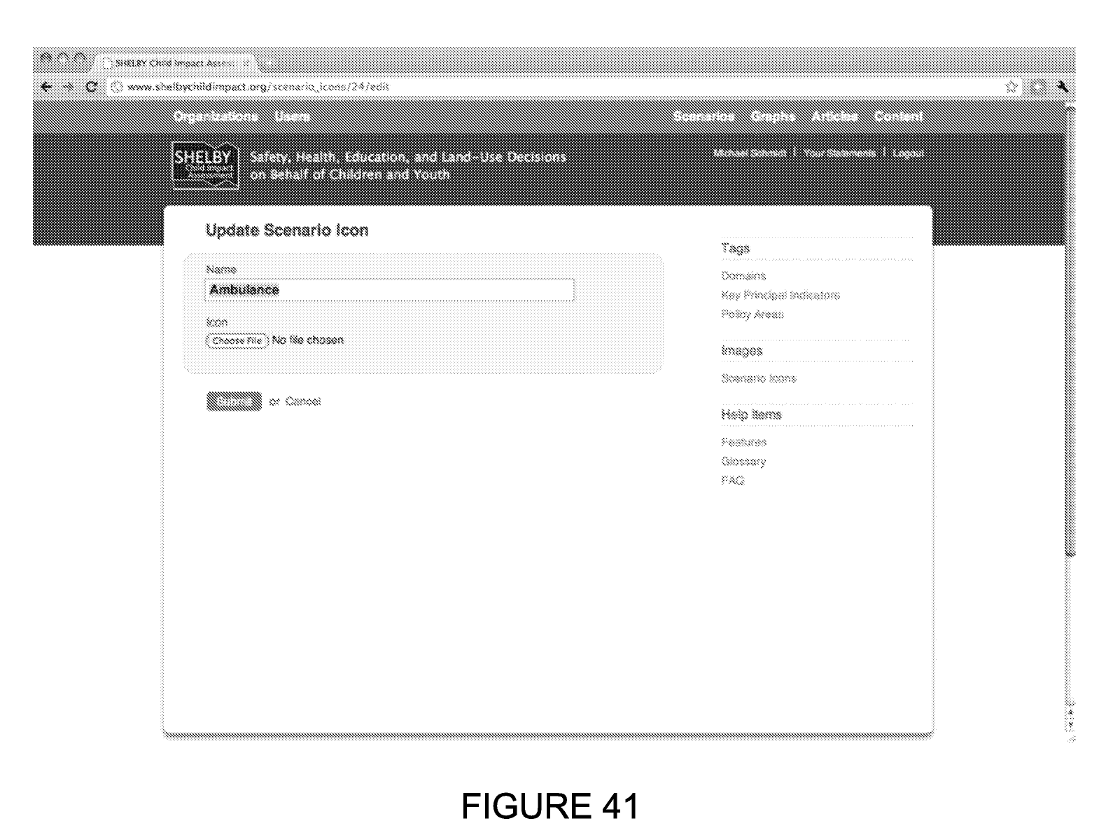

FIG. 36 shows an example of a master list of scenarios, which may be chosen by selecting “Scenarios” from the top of the interface. From this screen, a user can create a new scenario, or update an existing scenario, as shown in FIGS. 37-39. FIG. 40 shows an example of a master list of icons for use with a scenario, and includes the ability to create new or update existing scenario icons, as shown in FIG. 41.

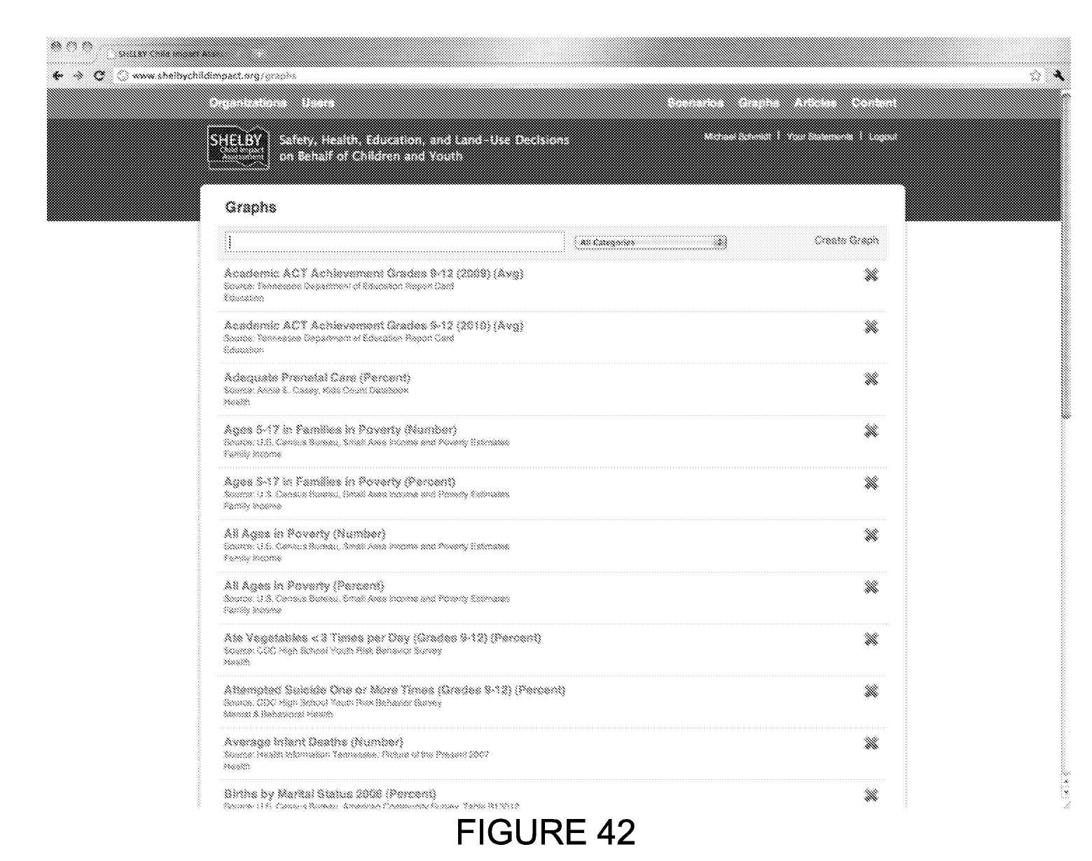

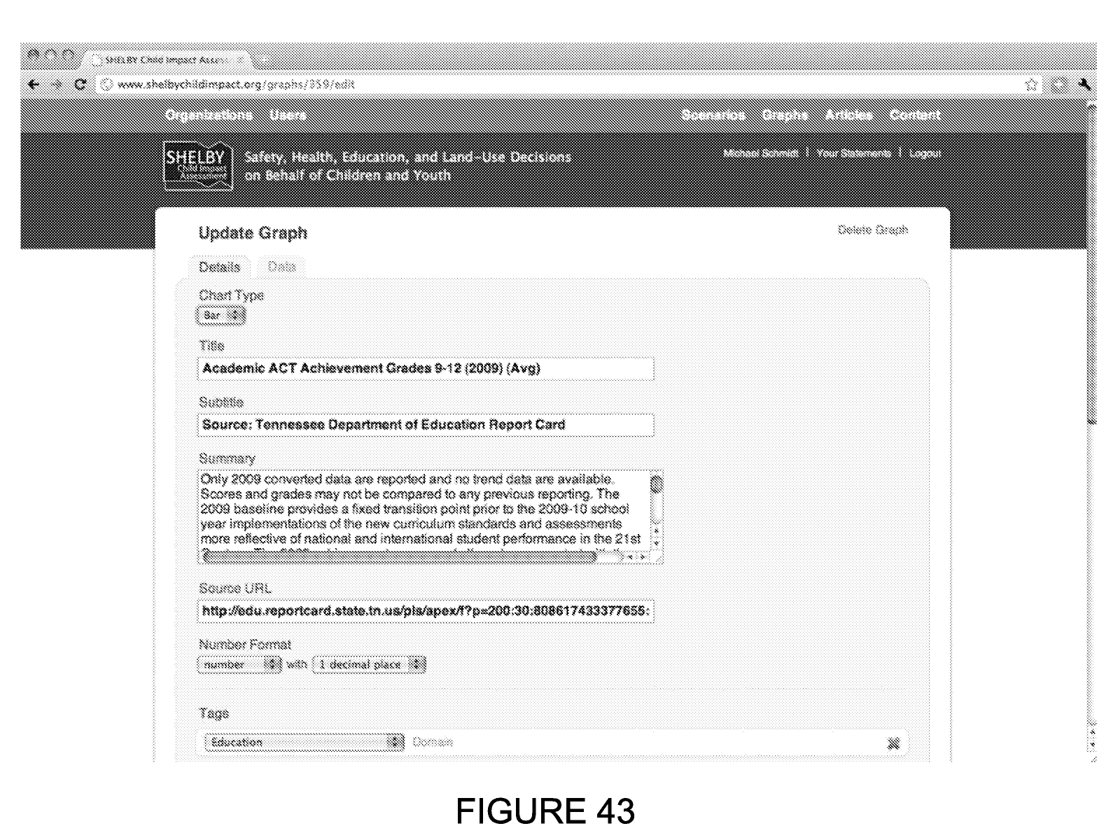

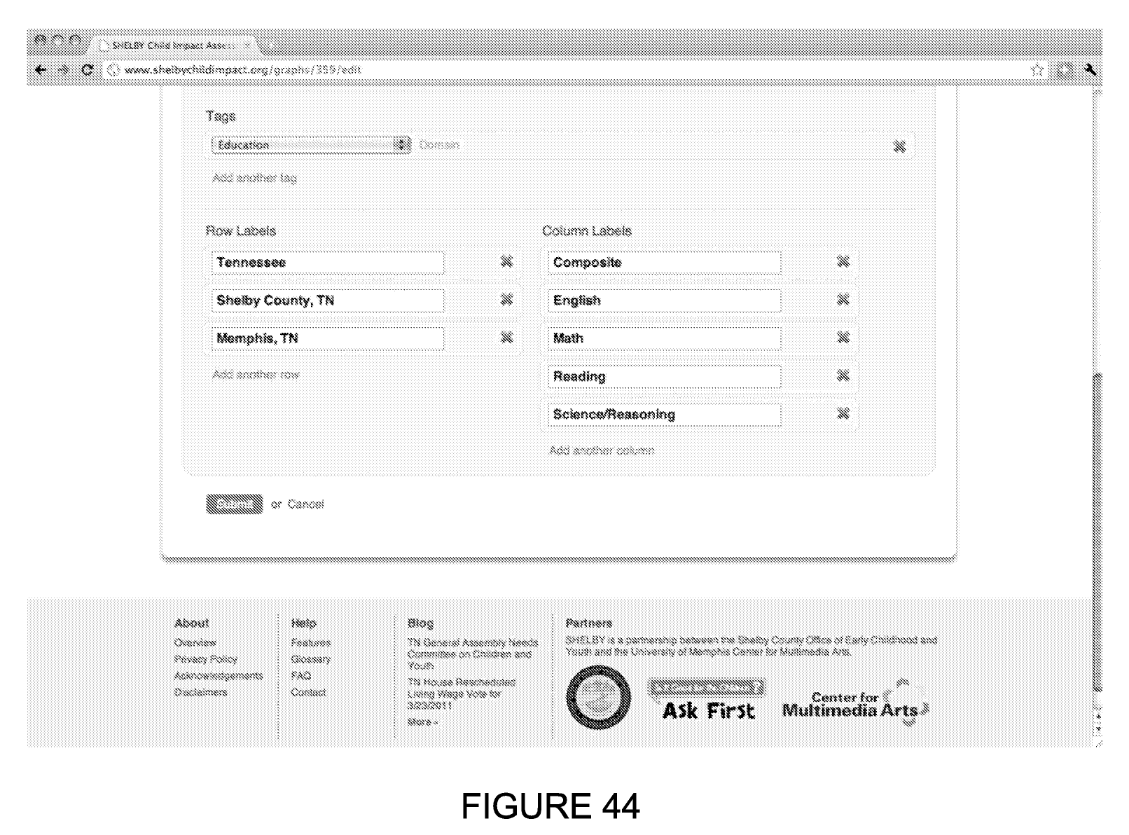

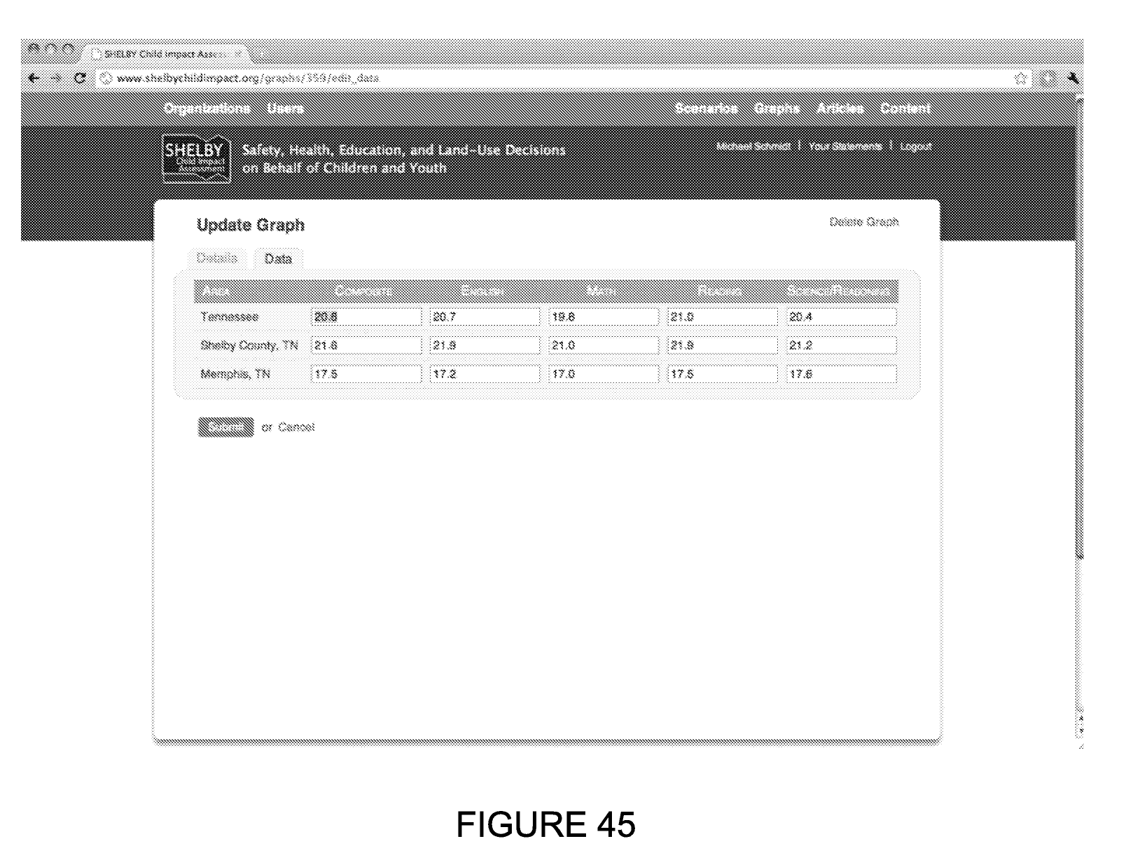

FIG. 42 shows an example of a master list of graphs, which may be chosen by selecting “Graphs” from the top of the interface. From this screen, a user can create a new graph, or update an existing graph, as shown in FIGS. 43-45.

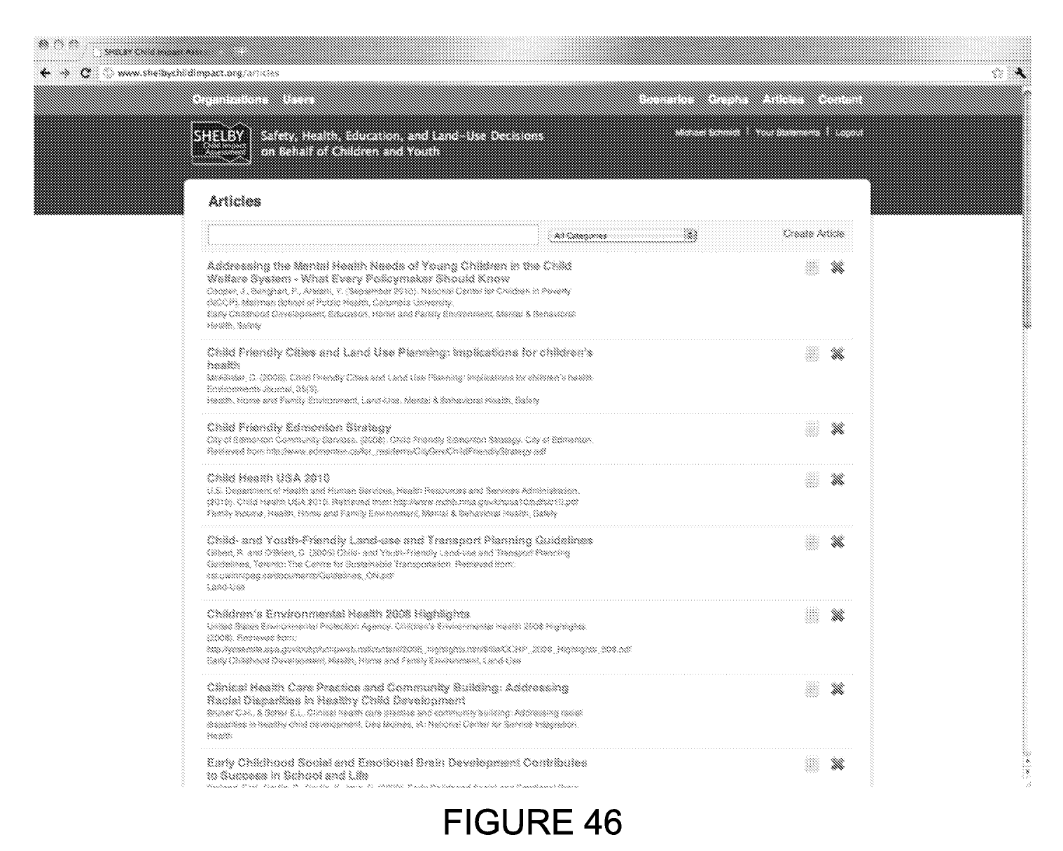

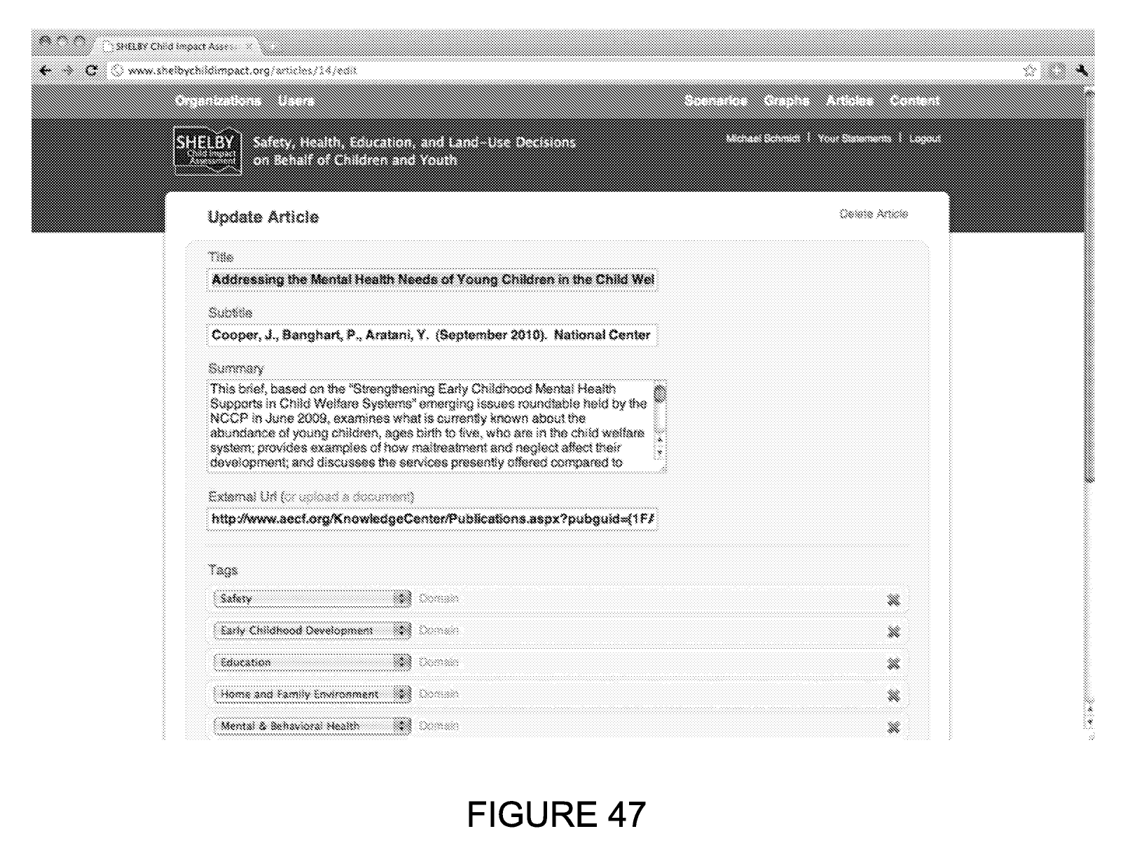

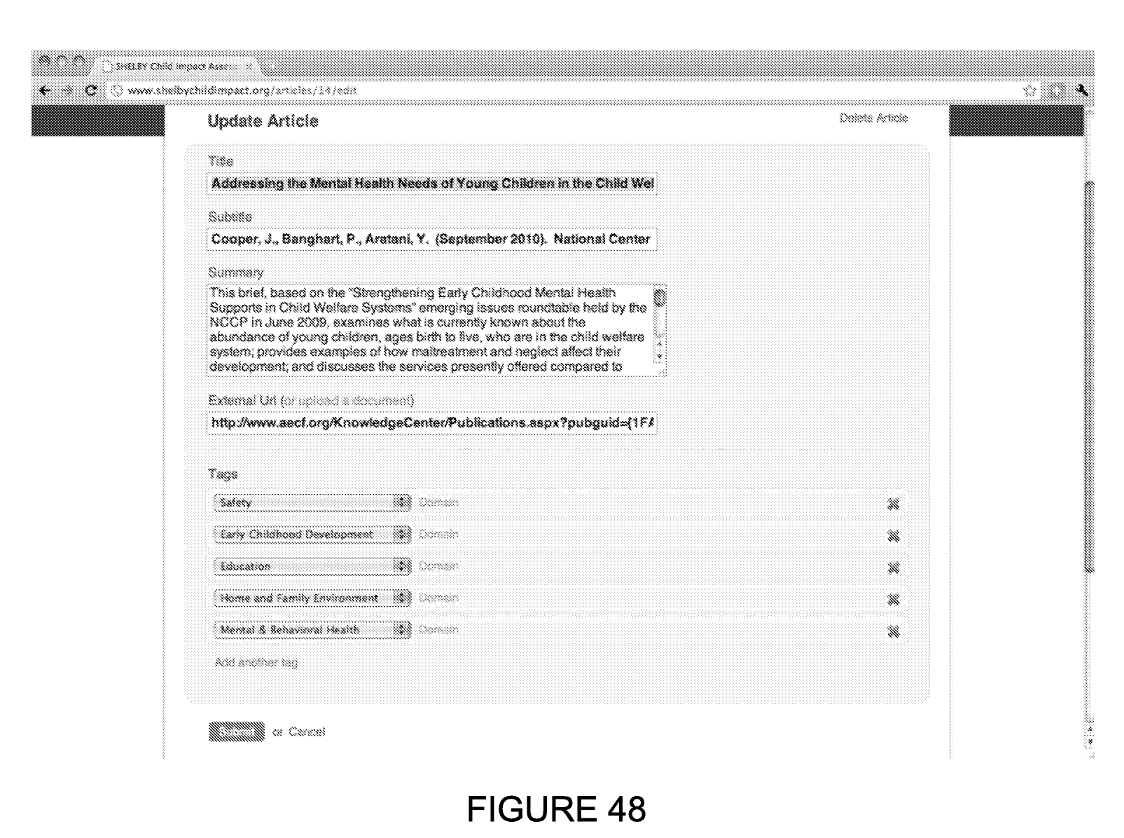

FIG. 46 shows an example of a master list of graphs, which may be chosen by selecting “Article” from the top of the interface. From this screen, a user can create a new article or article link, or update an existing article or article, as shown in FIGS. 47-48.

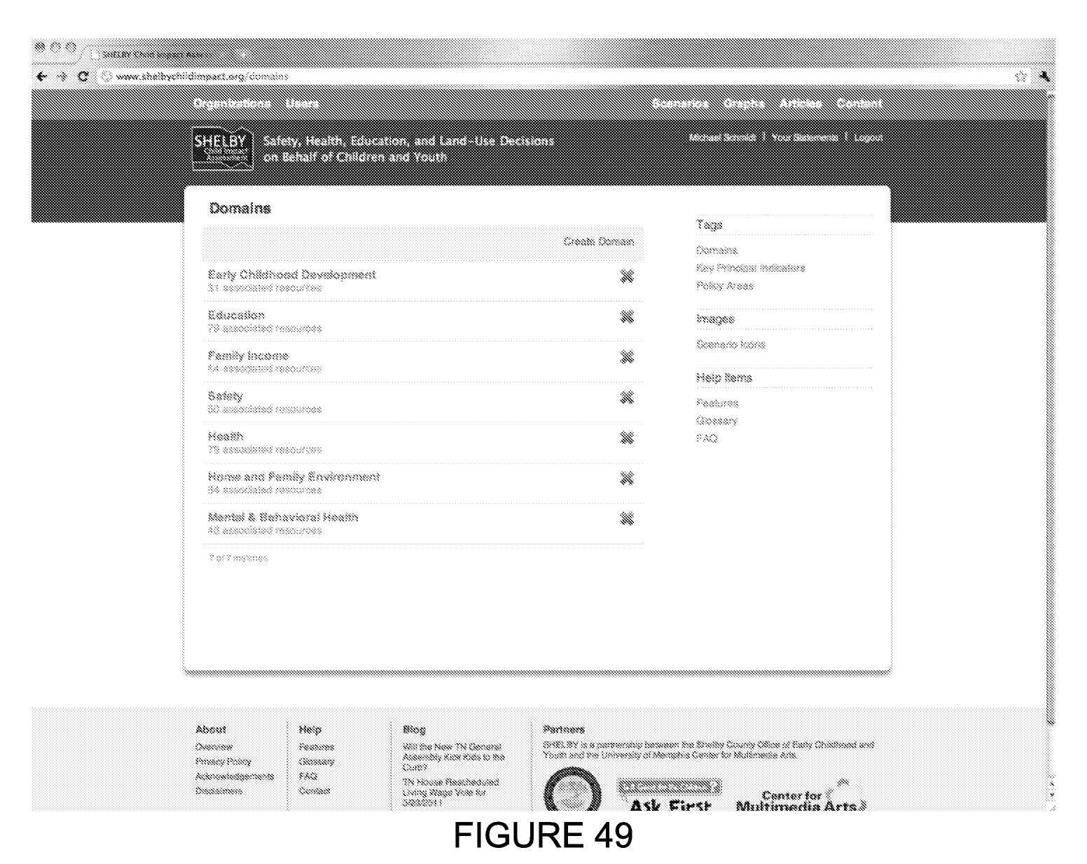

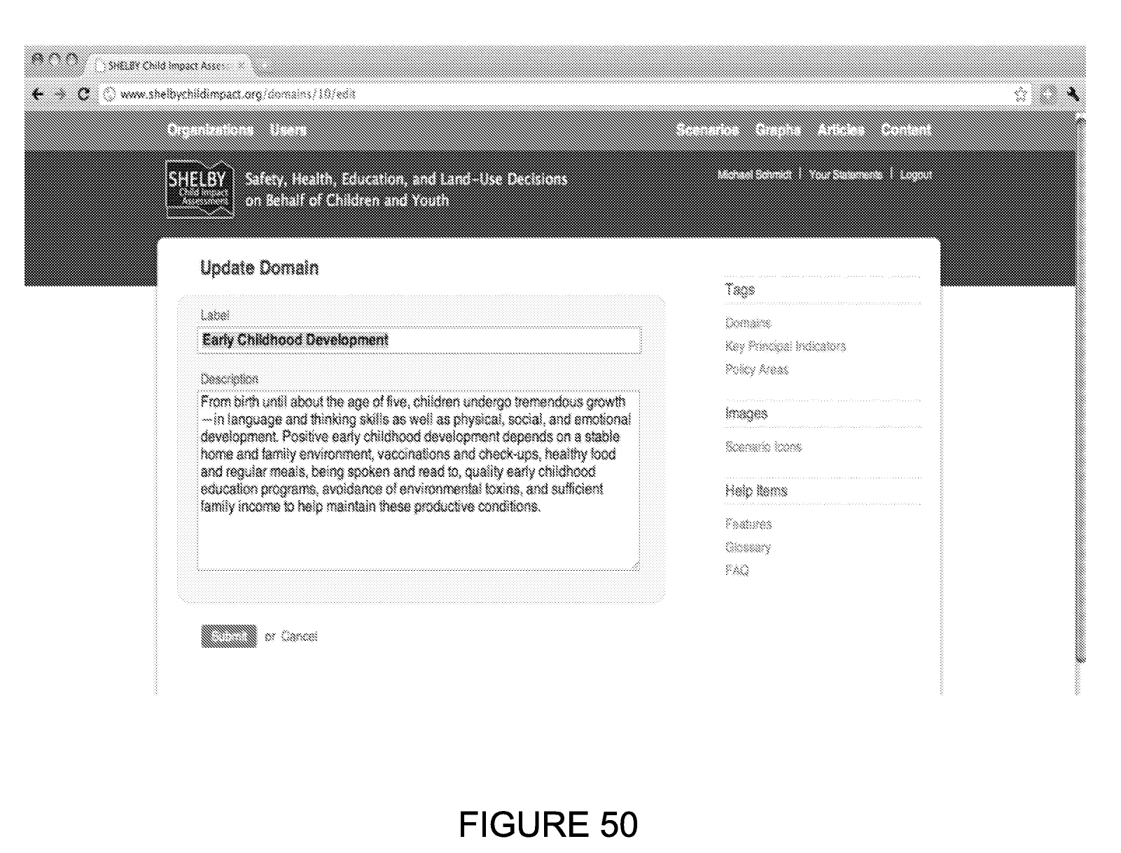

FIG. 49 shows an example of a master list of domains, which may be selected from the “Tags” section of the interface. From this screen, a user can create a new domain, or update an existing domain, as shown in FIG. 50.

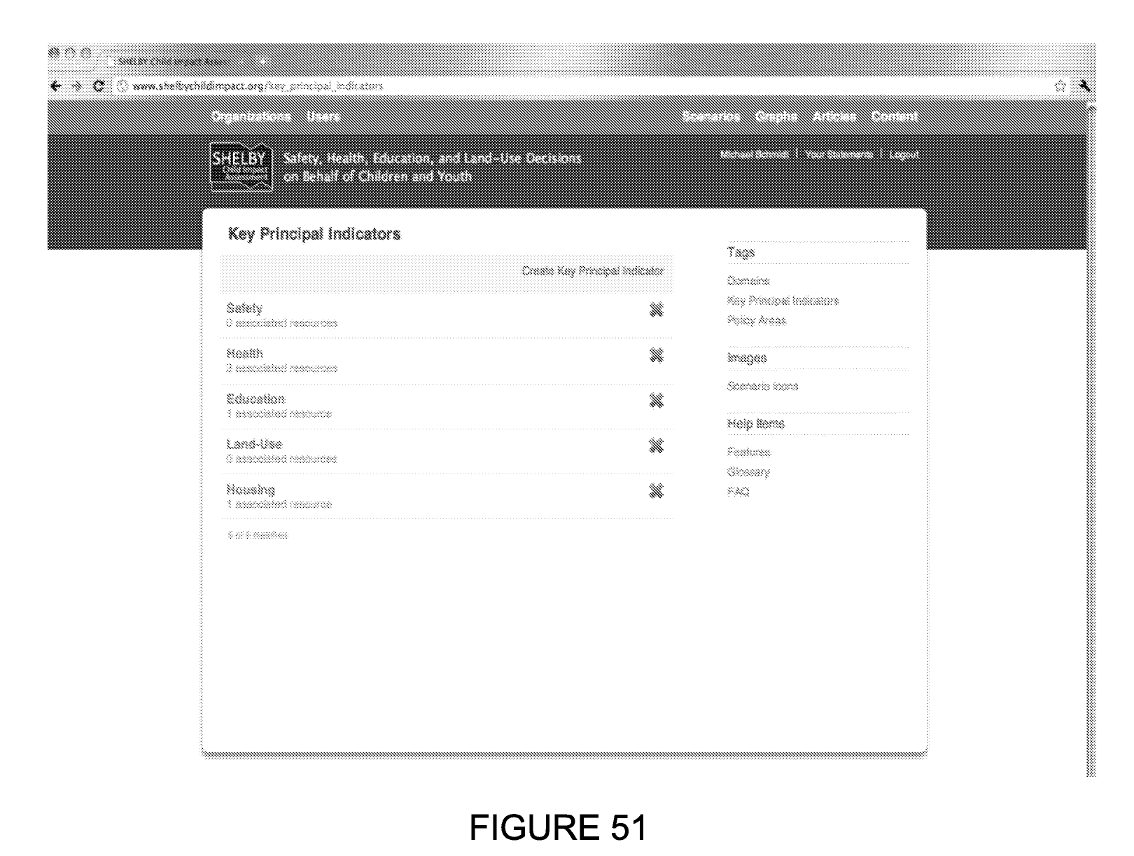

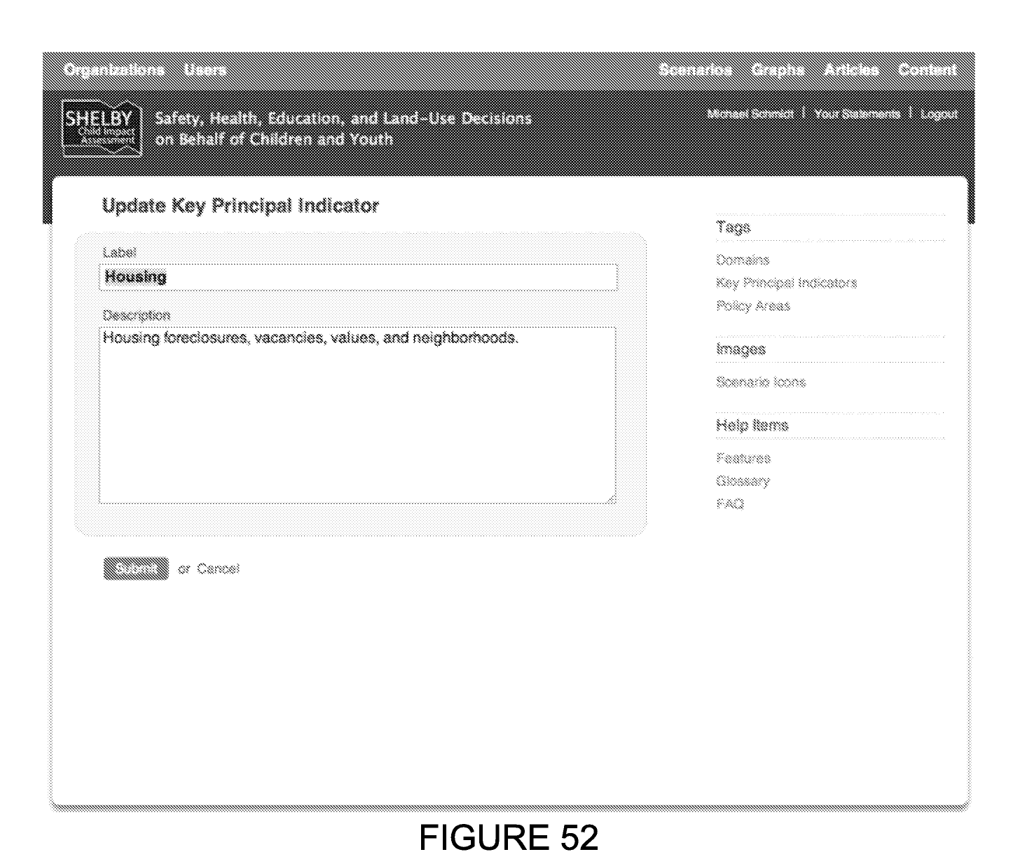

FIG. 51 shows an example of a master list of key principal indicators, which may be selected from the “Tags” section of the interface. From this screen, a user can create a new key principal indicator, or update an existing key principal indicator, as shown in FIG. 52.

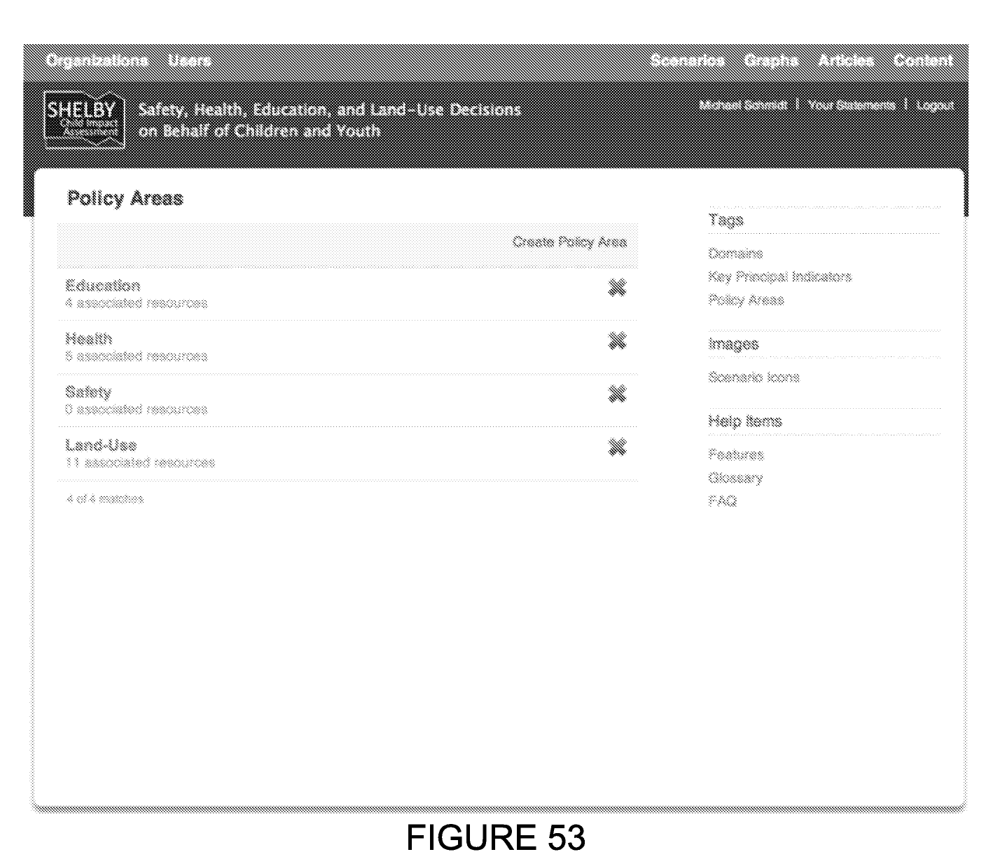

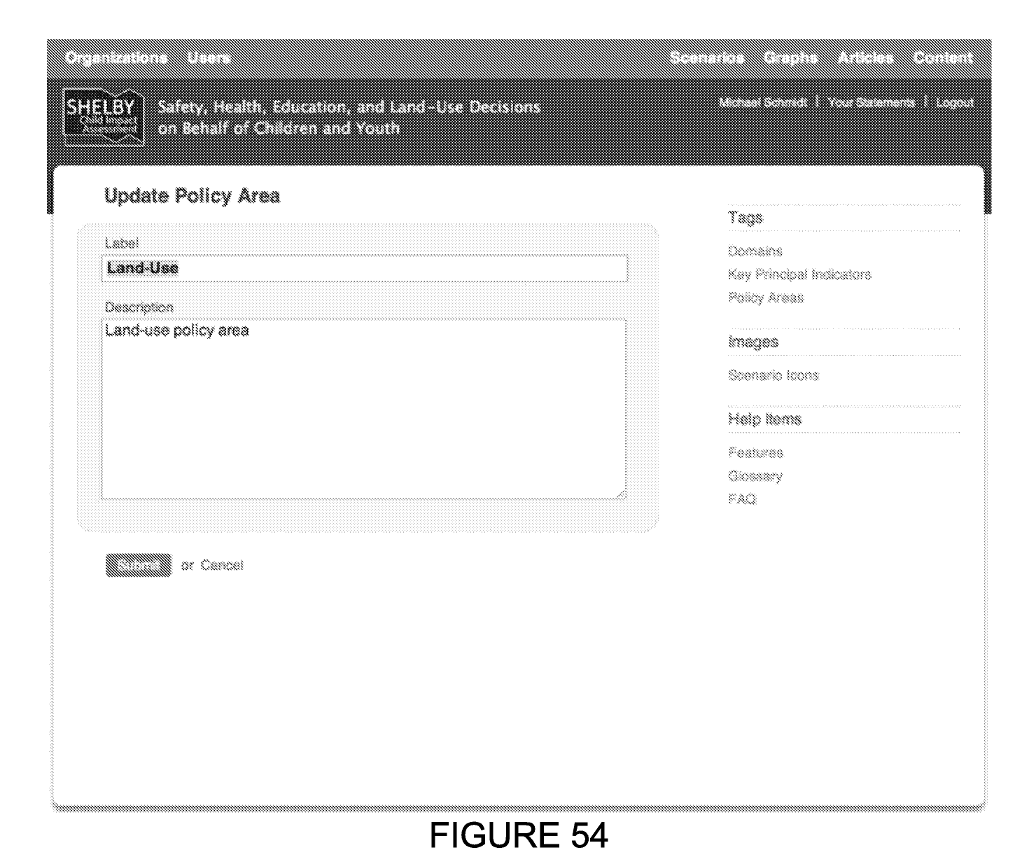

FIG. 53 shows an example of a master list of policy areas, which may be selected from the “Tags” section of the interface. From this screen, a user can create a new policy area, or update an existing policy, as shown in FIG. 54.

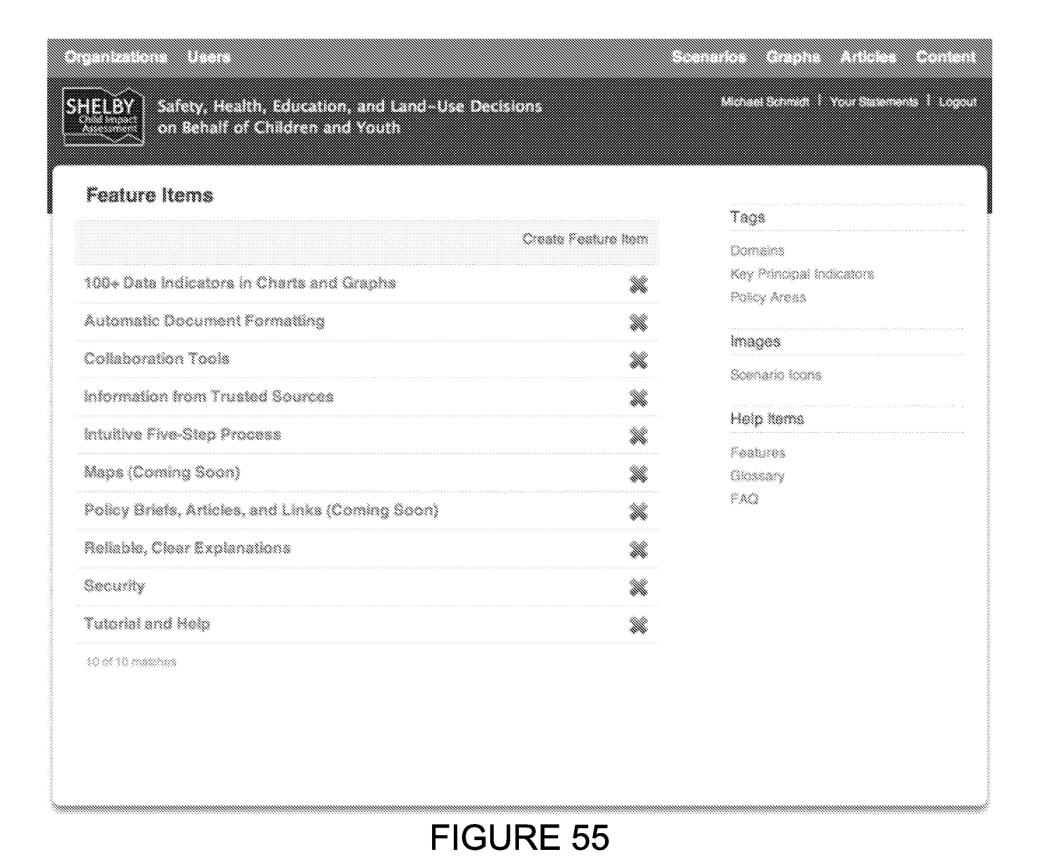

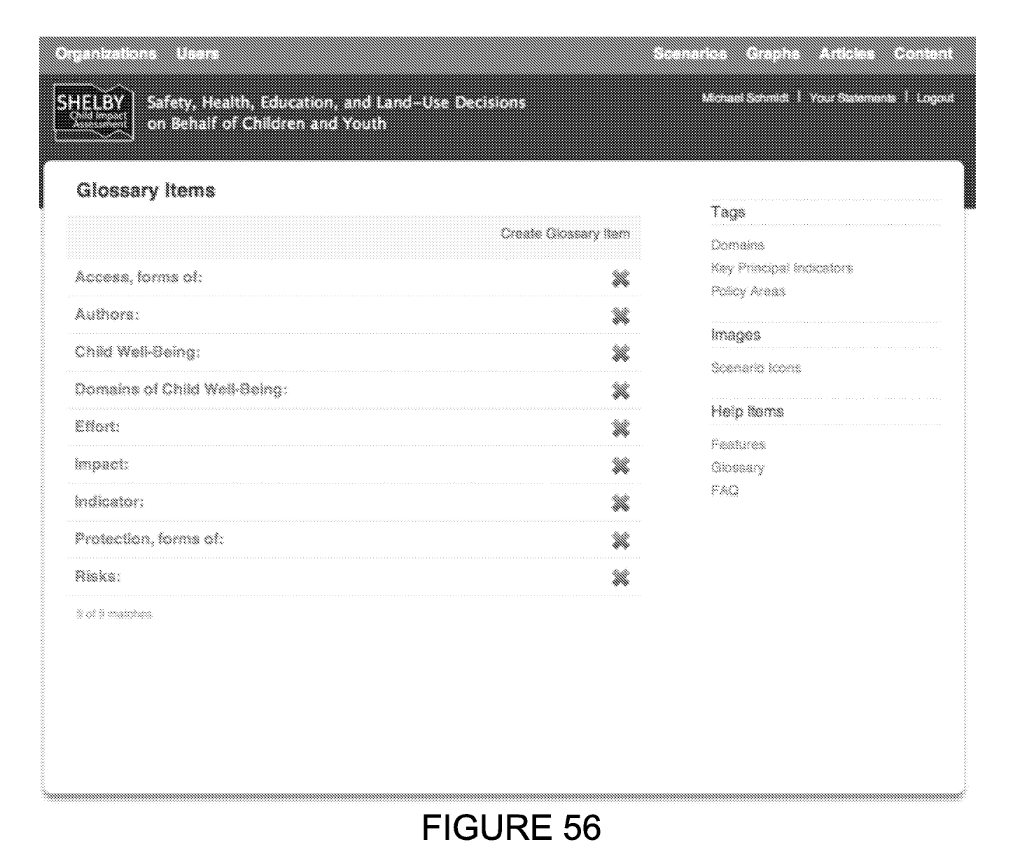

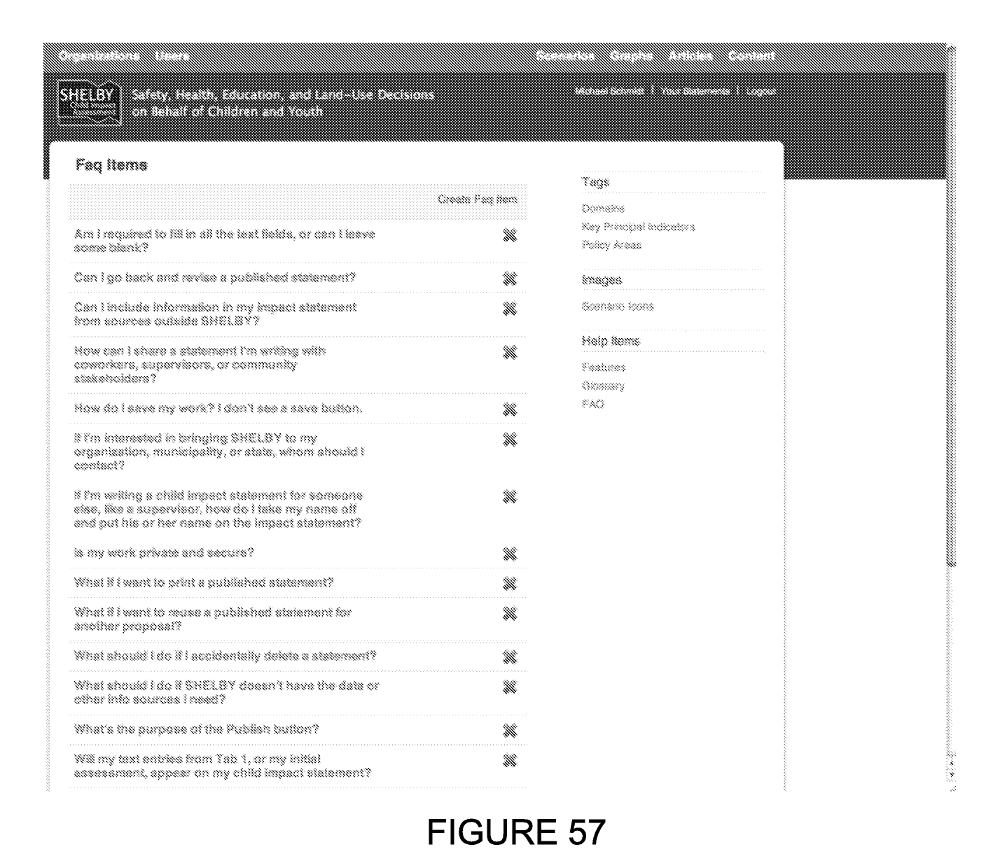

FIG. 55 shows an example of a master list of feature items, which may be selected from the “Help Items” section of the interface. From this screen, a user can create a new policy area, or update a feature item. Similarly, FIG. 56 shows a master list of glossary items, which be created or updated, and FIG. 57 shows a master list of FAQ items, which also may be created or updated.

In some embodiments, an administrative user may access the system through an administrator's interface. Functions available to an administrative user include adding, deleting or modifying user profiles, setting access levels for users, setting access levels for statements, and modifying data tables, among other functions.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A machine for creating a Child Impact Statement, comprising:
a processor or microprocessor coupled to a memory, wherein the processor or microprocessor is programmed to:
prompt a user to input an assessment of a problem or need;
prompt a user to input or select one or more applicable scenarios;
provide user access to a plurality of resources;
create customizable maps, charts, tables or graphs; and
automatically create a child impact statement based upon the user input and created maps, charts, tables or graphs.

2. The machine of claim 1, wherein the microprocessor is further programmed to prompt the user to reassess the input and content of the child impact statement.

3. The machine of claim 1, wherein the microprocessor is further programmed to prompt the user to rate the potential impact on children.

4. The machine of claim 1, wherein the child impact statement comprises a rating section, a summary section, an assessment section, and a research summary section.

5. A non-transitory computer-readable storage medium with an executable program stored thereon, wherein the program instructs a processor or microprocessor to perform the steps of:
prompting a user to input an assessment of a problem or need;
prompting a user to input or select one or more applicable scenarios;
providing a user access to a plurality of resources;
creating customizable maps, charts, tables or graphs; and
automatically creating a child impact statement based upon the user input and created maps, charts, tables or graphs.

6. The machine of claim 5, wherein the microprocessor is further programmed to perform the step of prompting the user to reassess the input and content of the child impact statement.

7. The machine of claim 5, wherein the microprocessor is further programmed to perform the step of prompting the user to rate the potential impact on children.

8. The machine of claim 5, wherein the child impact statement comprises a rating section, a summary section, an assessment section, and a research summary section.

9. A method of creating a Child Impact Statement, comprising the steps of:
prompting a user to input an assessment of a problem or need;
prompting a user to input or select one or more applicable scenarios;
providing a user access to a plurality of resources;
creating customizable maps, charts, tables or graphs; and
automatically, using a processor or microprocessor, creating a child impact statement based upon the user input and created maps, charts, tables or graphs.

10. The machine of claim 9, further comprising the step of prompting the user to reassess the input and content of the child impact statement.

11. The machine of claim 9, further comprising the step of prompting the user to rate the potential impact on children.

12. The machine of claim 9, wherein the child impact statement comprises a rating section, a summary section, an assessment section, and a research summary section.
